(19) United States
(12) Patent Application Publication
(10) Pub. No.: US 2014/0129320 A1
(43) Pub. Date: May 8, 2014

(54) B-MATCHING USING SUFFICIENT SELECTION BELIEF PROPAGATION

(71) Applicants: Tony Jebara, New York, NY (US); Bert Huang, Silver Spring, MD (US)

(72) Inventors: Tony Jebara, New York, NY (US); Bert Huang, Silver Spring, MD (US)

(73) Assignee: The Trustees of Columbia University in the City of New York, New York, NY (US)

(21) Appl. No.: 14/009,803

(22) PCT Filed: Apr. 5, 2012
(86) PCT No.: PCT/US12/32318

§ 371 Date: Dec. 17, 2013

Related U.S. Application Data
(60) Provisional application No. 61/472,038, filed on Apr. 5, 2011.

(51) Int. Cl. G06N 5/02; G06Q 30/02

(52) U.S. Cl. CPC G06N 5/022; G06Q 30/0243
USPC 705/14.42; 706/59

(57) ABSTRACT

A method, system, computer program product and computer readable media for b-matching using sufficient selection belief propagation is disclosed. The belief propagation method, is adapted to use a simplified compressed message update rule and is suitable for use with distributed processing systems. Embodiments for online advertisement/search term matching, product recommendation, dating service and social network matching, auction buyer/seller matching and resource allocation, among others, are disclosed.

### CROSS REFERENCE TO RELATED APPLICATIONS

This application claims the benefit of U.S. Provisional Application No. 61/472,038, filed on Apr. 5, 2011, which is incorporated herein by reference in its entirety.

### GOVERNMENT SUPPORT

This invention was made with government support under Grant No. DHS N66001-09-C-0080 awarded by DOD through subcontract from BAE. The government has certain rights in the invention.

### FIELD

Embodiments of the disclosed subject matter relate generally to matching, and, more particularly, to methods, systems, computer program products and computer readable media for b-matching using belief propagation.

### BACKGROUND

Computational systems and methods are used to facilitate many transactions and machine functions. Examples include network optimization, pattern matching, consumer recommender engines, homeland security, and others. Many systems employ computational models called network models or graphs which define links or edges between nodes. The links and nodes may be used to represent features of the problem space. Some techniques employ graphs solved for an optimized set of edges based on constraints on a respective number of edges that may connect each node and a respective value associated with the connection.

Matching problems, such as b-matching, have been solved using techniques such as linear programming. However, conventional techniques provide solutions to b-matching problems that are too slow and/or less than optimal. There exists a perennial need for new applications, speed improvements, reliability, and other advantages for such systems and methods.

### SUMMARY

Embodiments of the disclosed subject matter relate generally to systems, methods, programs, computer readable media, and devices that benefit from the optimization of links between things, for example, those that optimize computer transactions, provide certain types of machine intelligence, such as, pattern recognition, make and optimize recommendations to facilitate and others.

The disclosed embodiments can employ b-matching using belief propagation techniques that reduce memory cost and running time. The subject matter includes distributed or parallel processing embodiments.

In some embodiments, a recommender makes certain transactions available responsively to optimized matches between goods or services and machine representations of people or other entities. Often these kinds of matching problems present an opportunity to optimize some global good, such as revenue for a seller, likelihood of a recommended product or service to be well-received by a consumer, or optimal selection and placement of advertising messages on search result pages, web content pages or adjacent internet media. Such an optimized matching can be handled using various methods, one of which is solving a matching problem by estimating or inferring a subgraph that represents an optimal or desirable level of the global good, whatever that may be for a particular application.

Objects and advantages of embodiments of the disclosed subject matter will become apparent from the following description when considered in conjunction with the accompanying drawings.

### BRIEF DESCRIPTION OF THE DRAWINGS

Embodiments will hereinafter be described in detail below with reference to the accompanying drawings, wherein like reference numerals represent like elements. The accompanying drawings have not necessarily been drawn to scale. Where applicable, some features may not be illustrated to assist in the description of underlying features.

FIG. 1A is a chart of a method for matching using degree distribution information according to some embodiments of the disclosed subject matter.

FIG. 1B is a chart of a method for b-matching using sufficient selection belief propagation according to some embodiments of the disclosed subject matter.

FIG. 2 is a schematic diagram of a matching problem represented as a bipartite graph showing unmatched elements.

FIG. 3A is a schematic diagram of a matching problem represented as a bipartite graph showing matched elements, unmatched elements and a weight matrix, according to some embodiments of the disclosed subject matter.

FIG. 3B is a diagram of an arrangement for distributed processing for performing matching using degree distribution information according to some embodiments of the disclosed subject matter.

FIG. 4 is a schematic diagram of a weight matrix according to some embodiments of the disclosed subject matter.

FIG. 5 is a schematic diagram of degree distribution information according to some embodiments of the disclosed subject matter.

FIG. 6 is a chart of a method for generating an expanded weight matrix according to some embodiments of the disclosed subject matter.

FIG. 7A is a diagram showing expanded weight matrix coefficients generated according to some embodiments of the disclosed subject matter.

FIG. 7B is a schematic diagram showing an expanded weight matrix generated according to some embodiments of the disclosed subject matter.

FIG. 8 is a schematic diagram showing an expanded weight matrix after b-matching and conversion to binary values generated according to some embodiments of the disclosed subject matter.

FIG. 9 is a schematic diagram of a matching result obtained by truncating the binary expanded weight matrix shown in FIG. 8, according to some embodiments of the disclosed subject matter.

FIG. 10 is a schematic diagram of node degrees of the matching result shown in FIG. 9, according to some embodiments of the disclosed subject matter.

FIG. 11 is a diagram of a system for matching a first class of things to a second class of things using degree distribution information according to some embodiments of the disclosed subject matter.

FIG. 12 is a block diagram of a system for matching using degree distribution including parallel processors according to some embodiments of the disclosed subject matter.

FIG. 13 is a block diagram of a system for matching advertisers with search terms using degree distribution information and belief propagation according to some embodiments of the disclosed subject matter.

FIG. 14 is a block diagram of a system for matching dating service members using degree distribution and belief propagation according to some embodiments of the disclosed subject matter.

FIG. 15 is a diagram of a system for matching sellers and buyers in an auction using degree distribution and belief propagation according to some embodiments of the disclosed subject matter.

FIG. 16 is a diagram of a plurality of degree distribution matching/belief propagation processors implemented in hardware according to some embodiments of the disclosed subject matter.

### DETAILED DESCRIPTION

Deriving an optimized graph structure given partial information about nodes and/or edges may be used as a computational framework for machine intelligence engines such as used for matching advertisements to consumers, allocating limited offers or recommendations in search engine result pages, machine learning, matching of buyers and sellers in an auction system, matching users of social networks, and many other problems. Many of these systems and methods involve the optimizing of a subgraph from an original graph data structure.

Techniques have been developed for finding subgraphs from an original graph. However, conventional techniques may employ assumptions or compromises that fail to find global optima. More precise techniques suffer from execution times that are commercially unfeasible or undesirable for certain applications that may require relatively fast solution times.

Graph estimation can be used to match graph nodes of the same type with each other (e.g., unipartite graphs) or match nodes of a first type or class with nodes of a second type or class (e.g., bipartite graphs) with each other, and in other types of graphs. One type of matching is b-matching, where b represents the desired degree value for a result. Degree represents the number of connections or neighbors between nodes. The b value for matching can be a constant value and the same for all nodes. Alternatively, each node can have an independent b value that can be the same or different from that of the other nodes. Also, instead of being a constant value, the b value can be described as a distribution over a range of values. Problem types that include distributions of b-values (or degrees of connectedness between nodes) are known as degree distribution problems.

Examples of degree distribution problems include auctions where each buyer and seller may select an independent number (or capacity) of corresponding buyers/sellers or may have a range of capacities they can handle but which may incur different costs. Also a degree distribution problem can arise for cases in which the capacity changes over time, such as when a desired number of possible connections changes according to a quota which varies dynamically. Conventional approaches to solving b-matching problems may not be effective for solving degree distribution problems.

In general, many types of real-world problems can be represented as a graph for purposes of finding a solution to the problem using a computer programmed to solve a specific type of graph matching problem representing the real-world problem. The graph can include nodes that can be potentially connected via edges. Each edge in the graph can have a weight value representing a quantity such as cost, profit, compatibility, or the like. A solution to the problem can be represented as a subgraph of the original graph, the solution subgraph can be considered optimal if the subgraph maximizes the weight values.

For example, the problem of providing matches between online dating service users can be represented in a machine storing a representation of a bipartite graph (G) composed of a first group of nodes (v) representing males and a second group of nodes (μ) representing females. Edges (ε) in the graph can represent a potential match between two members (or nodes). A weight matrix can include weight values (W) for each edge representing a compatibility measure between the pair of male and female user nodes connected by the edge.

An optimal solution to the online dating graph problem may be represented as a subgraph having edges connecting each member to those opposite members that are determined to be the most likely matches such that the subgraph produces a maximum or near-maximum compatibility value. The edge weight values for the online dating service problem can be compatibility index values that represent compatibility values for the respective edges (or connections) between respective members on the graph. The compatibility index value can be computed by any suitable process or system, for example, collaborative filtering, matching of profiles based on similarity or more complex rules, etc.

In addition to the online dating matching problem having an original graph representing the dating service members and a weight matrix containing compatibility index values for matches between users, there can also be a degree distribution (ψ) for each member. The degree distribution indicates the degree (or number of connections) preference of a node.

For example, in the dating service example, a degree distribution can represent the number of matches that a user has paid to receive, the number of matches that a user expects to be able to adequately evaluate within a certain time period, or the like. Generally speaking, the degree distribution for a node represents the degree preference for the node and can be used to encourage a graph solution for that node to have a desired number of connections, while numerically discouraging or penalizing undesired numbers of connections. Each node can have its own degree distribution.

A graph representing a matching problem including degree distributions can be transformed into an expanded graph (G_{b}) and expanded weight matrix solvable using b-matching with fixed degrees to arrive at a solution that takes into account the degree distributions of the original problem. The expanded graph includes the original graph nodes as well as additional dummy nodes (d) and the expanded weight matrix includes the original weight values as well as additional weight values (ω) determined based on the degree distribution values and that correspond to the edges (E_{b}) between original nodes and dummy nodes. By creating an expanded graph and weight matrix, the degree distribution values are incorporated into the weight matrix so that a b-matching solution of the expanded graph will reflect the degree distribution values for each node.

Returning to the online dating problem, each dating service member can have an associated degree distribution that represents a desired number of matches. An expanded graph is created using the original graph and dummy nodes. An expanded weight matrix is created using the original weight matrix and weight values for the dummy nodes that are determined using the degree distribution values.

Then, b-matching is performed to solve for a maximum weight subgraph of the expanded graph and weight matrix. The b-matching can be performed using a maximum likelihood estimation or a loopy belief propagation as described in greater detail below. A portion of the solution graph to the expanded graph is extracted and represents the solution to the original graph with degree distributions being considered in the solution.

Maximum weight b-matching is a combinatorial optimization which has natural application in optimization of resource-allocation problems as well as network construction.

While b-matching outputs a graph constrained to predetermined node degrees, a degree-based matching outputs a graph by optimizing real-valued degree-preference scores associated with each node. The degree-based matching problem is thus interpretable as maximum likelihood inference of graph structure given potential factors dependent on edges as well as node-degrees.

Finding a maximum weight subgraph is a useful problem in classical applications such as resource allocation, where costs may be associated with increasing node degrees that offset rewards for increased edge connectivity. In such allocation problems, nodes correspond to both resource producers and consumers while edges may correspond to assignments between the producers and consumers. Physical or economic restrictions may limit or penalize producers who are assigned too many or too few consumers, and vice versa, leading to a natural application of degree-based subgraph estimation. Formulations for these problems, such as the linear assignment problem, allow hard-constraints on degrees, and the methods described herein generalize these formulations to allow penalized degrees, or soft-constraints.

To solve the maximum weight b-matching, a belief propagation-based algorithm can be used. Belief propagation is an approximate inference technique for Markov random field (MRF) representations of probability distributions. A Markov random field describes a probability distribution function as a product of factors over groups of dependent random variables, where each non-overlapping pair of groups is considered Markov independent, or is independent given the states of all other groups. This technique can use a pairwise MRF, in which all groups are of at most two random variables. Belief propagation assigns beliefs for each group and passes messages between the groups to resolve inconsistencies. The two main variants of belief propagation are the sum-product algorithm and the max-product algorithm.

The sum-product algorithm aims to compute the marginal probabilities of each variable group, which are the total joint likelihoods of each variable state. In contrast, the max-product algorithm aims to compute the max-marginals of each group, which are the maximum possible joint likelihoods given each state of the group's variables.

An alternate probabilistic framework to Markov random fields is the factor graph model, in which probability distributions are expressed as a bipartite graph between variable nodes and factor nodes. The factor graph gives another derivation and interpretation of belief propagation for maximum weight b-matching, however the final implementation remains the same. The factor graph formulation has been used to implement affinity propagation algorithms where reasoning with high-order factor potentials allows for simplification of the message passing.

Belief propagation can be used on cyclic graphical models in practice, despite the fact that neither convergence nor correctness of the resulting marginals is guaranteed in general.

Theoretical guarantees on the performance of belief propagation on certain classes of loopy graphical models are thus important. In a graphical model with a single loop, max-product belief propagation converges and yields the true solution. Max-product converges on a graphical model representing bipartite maximum weight matching in a bounded number of iterations. A similar analysis can be extended to bipartite b-matching. In any matching graph, tightness of the linear programming (LP) relaxation is a necessary and sufficient condition for guaranteed convergence of max-product. While combinatorial algorithms such as balanced network flow solve maximum weight b-matching, the belief propagation approaches provide lightweight algorithms with simple update formulas and natural parallelization schemes.

Belief propagation has been shown in some cases to have theoretically optimal running time. Belief propagation has a constant iteration count for convergence on bipartite 1-matching on graphs where the edge costs are drawn independently and identically distributed (i.i.d.) from a light-tailed distribution. Under a light-tailed distribution, large weights are unlikely, allowing that for any error threshold ε>0, there exists a number of iterations h(ε) and graph size N(ε) such that after h(ε) iterations of belief propagation, the fraction of suboptimal assignments is less than ε. For graphs of size greater than N(ε), the number of iterations to the convergence threshold thus does not depend on N. Since each iteration costs O(N²), the total expected cost of solving bipartite 1-matching is O(N²) quadratic.

Faster standard max-product updates are possible by exploiting repeated potentials, which can be sorted in advance of message updates. Each message update, which involves a maximization over potential sums, can use the sorted orders such that the expected running time of each update for variables with N settings is O(√N). This speedup is particularly useful when variables have many possible settings or factors are high-order, which is the case in the generalized matching function.

In the bipartite case, the maximum weight matching problem is also known as the assignment problem. Classical approaches to finding the maximum weight bipartite matching include the augmenting path algorithm, the Hungarian algorithm, and minimum-cost maximum flow approaches.

Various advances on fast solvers for maximum weight matching have been proposed. For graphs restricted to nonnegative integer weights, the bipartite maximum weight 1-matching problem was shown to be solvable in O(√(|V|)|E|log(|V|)) time. An O~(|V|^{2.376}) randomized algorithm for integer weights which succeeds with high probability has also been known. Subsequently, a (1−ε) approximation algorithm for nonbipartite maximum weight matching with real weights runs in O(|E|ε⁽⁻²⁾ log³|V|) time.

The maximum weight perfect b-matching problem is a generalization of maximum weight matching in which the solver is given a weighted graph and a set of target degrees, and must output the maximum weight induced subgraph such that each node has its target number of neighbors.

A bipartite dense maximum weight perfect b-matching problem is, given a dense, bipartite graph, in which all pairs of points that cross bipartitions have candidate edges and a target degree for each node, to find the maximum weight induced subgraph such that the nodes in the subgraph have their target degrees.

Generally, the maximum weight perfect b-matching problem is solvable in O(|V∥E|) time with min-cost flow methods. In problems with dense graphs, the running time for b-matching solvers is O(N³), where N=|V|.

Disclosed embodiments describe improved algorithms for weighted b-matching that significantly reduce the memory cost and the running time for solving b-matching. Specifically, in problems where the edge weights are determined by a function of node descriptors, the space requirement is reduced to O(N) and the running time can be reduced to O(N^{2.5}) in some cases (but no worse than previous algorithms in adversarial cases). Both improvements are on each iteration of belief propagation, and the resulting algorithm computes the original belief updates exactly, so any previous analysis of the number of iterations necessary for convergence remains intact. The memory bottleneck is reduced by unrolling one level of recursion in the belief updates such that the explicit belief need not be stored, and the running time improvement is achieved by a variant of the algorithm, in which speedups are available by decomposing a maximization procedure into the maximization of two components.

The following paragraphs describe various specific embodiments of techniques matching using degree distribution with improved algorithms that reduce memory costs and the running time for solving b-matching. These techniques may be used as a basis for a variety of devices, systems, and methods.

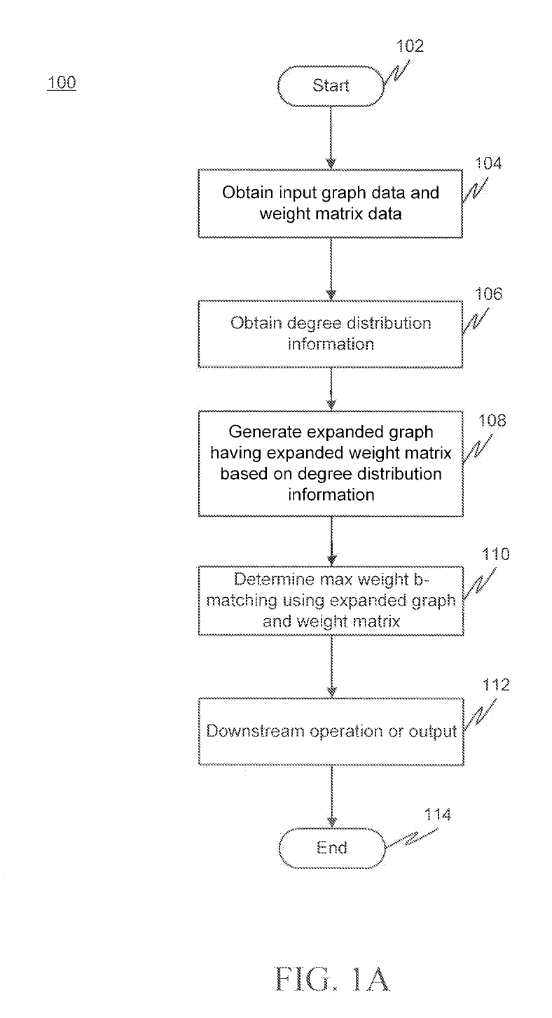

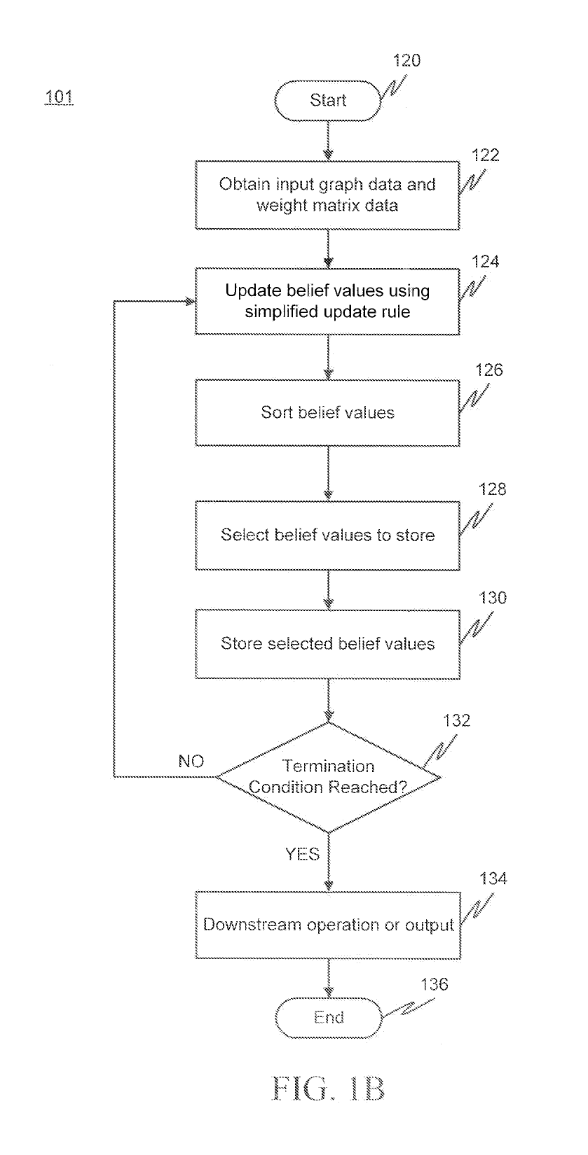

FIG. 1A is a chart of a method for matching using degree distribution information according to some embodiments of the disclosed subject matter. In particular, in method 100 processing begins at 102 and continues to 104.

At 104, an input graph data structure and corresponding weight data are obtained. The input graph data structure can be a unipartite, bipartite, or other type of graph data structure. The graph data structure can be any type of graph data structure suitable for use with generalized matching using belief propagation, such as a bipartite graph data structure. Other examples of graph data structures are described below with respect to other embodiments.

The graph data structure can contain one or more nodes of the same or different type. For example, the graph data structure can include supplier nodes and customer nodes, where each supplier node can be connected to one or more customer nodes, and vice versa. The graph node data structure elements can correspond to physical entities such as suppliers, customers, goods and/or services. In addition, the nodes can correspond to other entities as described below with respect to other embodiments.

The weight data represents a weight (or a profit, cost, or other measure) of an edge between two nodes in the graph data. The input graph data structure can have a weight matrix A such that the weight of an edge (uᵢ, vⱼ) is Aᵢⱼ. The weight matrix represents a profit value (profit matrix) or a cost value (cost matrix) for each edge between two nodes of the graph data structure. In the case of a profit matrix, the matching process typically includes a function to enhance and/or maximize profit. And in the case of a cost matrix, the matching process typically includes a function to reduce and/or minimize cost. The values in the profit matrix can be negative, zero, positive or a combination of these values.

An exemplary profit matrix may be represented by a data structure having a record corresponding to each node. The record for each node can include a list of adjacent nodes and a profit value for each of the adjacent nodes. The items of data in the profit matrix can represent physical entities or values such as actual supplier capacity, actual customer demand, monetary amounts of bidding or asking prices, monetary amounts of profit, distances, monetary costs, and/or the like. A portion of the profit matrix can be selected and provided to each node. The selected portion can represent only the profit matrix record corresponding to each respective node. By providing only a portion of the profit matrix to each node, data storage and transfer requirements can be reduced.

At 106, degree distribution information is obtained. The degree distribution information includes degree distribution information for each node in the input graph data structure. The degree distribution information can include prior distribution over node degrees, degree information inferred from statistical sampling properties, degree distributions learned empirically from data, given degree probabilities, or the like. The degree distribution for each node can be specified by a term ψⱼ.

At 108, a new graph data structure is generated that includes dummy nodes in addition to the nodes of the input graph data structure. There are an additional number of dummy nodes equal to each set of nodes in the input graph. An expanded weight matrix is generated using the input weight matrix as the weight values for the input nodes in the expanded weight matrix and degree distribution information is used to determine a weight value for edges between input nodes and dummy nodes, according to the following formula:

w(vᵢ,d_{i,j})=ψᵢ(j−1)−ψᵢ(j). (1)

Processing continues to 110.

At 110, a maximum weight b-matching operation is performed on the expanded graph data structure and weight matrix. Depending on the structure of the input graph data, a maximum likelihood estimation method or a belief propagation method can be used to determine the maximum weight b-matching. During the maximum weight b-matching, b is set to the size of a dimension of the original weight matrix (e.g., if the original weight matrix is an n×n matrix, then b=n). The b-matching is generally characterized by a function M(uᵢ) or M(vⱼ). Function M returns the set of neighbor vertices (or nodes) of the input vertex (or node) in the b-matching. In general, the b-matching objective function can be written as:

$$W ( M ) = {max}_{M} {\sum }_{i = 1}^{n} {\sum }_{{v}_{k} ∈ M ( {u}_{i} )} {A}_{ik} + {\sum }_{j = 1}^{n} {\sum }_{{u}_{i} ∈ M ( {v}_{i} )} {A}_{ij} \\ s . t . \\ \vert M ( {u}_{i} ) \vert = b , ∀ i ∈ \{ 1 , … , n \} \\ \vert M ( {v}_{j} ) \vert = b , ∀ j ∈ \{ 1 , … , n \} \qquad ( 2 )$$

If variables xᵢεX and yⱼεY for each vertex are defined such that xᵢ=M(uᵢ) and yⱼ=M(vⱼ), the following potential functions can be defined:

$$φ ( {x}_{i} ) = exp ( {\sum }_{{v}_{j} ∈ {x}_{i}} {A}_{ij} ) , \\ φ ( {y}_{j} ) = exp ( {\sum }_{{u}_{i} ∈ {y}_{j}} {A}_{ij} )$$

and clique function:

ψ(xᵢ,yⱼ)= [symbol] (vⱼεxᵢ⊕uᵢεyⱼ). (3)

Using the potentials and clique function, the weighted b-matching objective as a probability distribution p(X,Y)∝exp(W(M)) can be expressed as follows:

$$p ( X , Y ) = \frac{1}{Z} {\prod }_{i = 1}^{n} {\prod }_{j = 1}^{n} ψ ( {x}_{i} , {y}_{j} ) {\prod }_{k = 1}^{n} φ ( {x}_{k} ) φ ( {y}_{k} ) \qquad ( 4 )$$

The probability function (4) above can be maximized using a max-product algorithm. The max-product algorithm iteratively passes messages between dependent variables and stores beliefs, which are estimates of max-marginals. Conventionally, messages are represented by vectors over settings of the variables. The following are the update equations from xᵢ to yⱼ.

$$\begin{matrix}{m}_{{x}_{i}} ( {y}_{j} ) = \frac{1}{Z} {max}_{{x}_{i}} [ φ ( {x}_{i} ) ψ ( {x}_{i} , {y}_{j} ) {\prod }_{k \neq j} {m}_{{y}_{k}} ( {x}_{i} ) ] & ( 5 ) \\ b ( {x}_{i} ) = \frac{1}{Z} φ ( {x}_{i} ) {\prod }_{k} {m}_{{y}_{k}} ( {x}_{i} ) & ( 6 )\end{matrix}$$

Direct belief propagation on larger graphs using the above equations converges, but may not be suitable due to the number of possible settings for each variable.

In order to quickly solve a b-matching problem using belief propagation, while still maintaining algorithm guarantees, several improvements over conventional direct belief propagation are needed. These improvements are described in detail below and include generating a simplified update rule, simplifying the messages by unrolling recursion, and updating messages using sufficient selection.

The framework of solving b-matching problem is as follows: (1) expressing the b-matching problem; (2) performing maximum likelihood estimation or belief propagation to compute the max-product message update; (3) simplifying messages; and (4) updating messages using sufficient selection.

(1) Expressing the b-Matching Problem

(a) Maximum Weight Matching

The general framework of a classical problem of maximum weight matching is: given a weighted, undirected graph G={V, E, w}, where E is a set of node pairs (u, v)εE, u, vεV, and w(e) [symbol] R is a function that maps edges to their weights, a matching-like problem is solved by finding the spanning subgraph or factor of G that has maximum weight subject to constraints on the degrees of nodes in Ĝ. A spanning subgraph Ĝ={V, Ê, w} is a graph that shares the same node-set V with G but whose edge-set Ê⊂E is a subset of the original edge-set E. Thus, each problem is an optimization of the form:

\hat{E}=argmax_{E,⊂E}Σ_{(u,v)εE},w(u,v)s·t·C(E′), (7)

where C is a set of requirements dependent on the degrees. In the standard maximum-weight matching problem, the degree requirements are that each degree is no more than one, or in the maximum-weight perfect matching problem, the requirements are that each degree is exactly one.

Generalized matching extends maximum weight matching to allow degrees other than one. In b-matching problems, the maximum and target degrees are defined by a set of non-negative integers bᵥ for each vεV, such that in the maximum-weight b-matching problem, each node v must have degree no more than bᵥ and in the maximum-weight perfect b-matching problem, each node v must have exactly degree bᵥ.

A further generalization of b-matching is degree constrained subgraph (DCS), in which each node's degree is subject to a lower and upper bound. Thus, degree constrained subgraph subsumes perfect and non-perfect b-matching, e.g., the perfect b-matching problem can be represented by setting the lower and upper bounds to be equal. DCS also generalizes the b-cover problem, which finds graphs where nodes have at least b adjacent edges. Table 1 lists the constraints for each of these generalized matching problems.

TABLE 1
Constraints for maximum-weight generalized
matching problems. Each problem is solved by
maximizing the total weights of active edges subject to the
constraints listed above. The function deg(v, E′) is the degree of
node v in edge-set E′, i.e., the number of edges adjacent to v.

| Problem | Standard constraints | | Perfect constraints | |
|---|---|---|---|---|
| matching | deg(v, E′) ≦ 1, | ∀v ε V | deg(v, E′) = 1, | ∀v ε V |
| b-matching | deg(v, E′) ≦ bᵥ, | ∀v ε V | deg(v, E′) = bᵥ, | ∀v ε V |
| b-cover | deg(v, E′) ≧ bᵥ, | ∀v ε V | deg(v, E′) = bᵥ, | ∀v ε V |
| DCS | bᵥ ≦ deg(v, E′) ≦ bᵥ′, | ∀v ε V | | |

(b) Degree-Based Matching

A larger class of problems is the maximum-weight degree-based spanning subgraph problem, or degree-based matching, where the set of feasible spanning subgraphs is unconstrained, but instead penalized according to functions of node degrees. The problem class is so named because these functions are interpretable as degree-based potentials in a probabilistic interpretation of the maximum weight spanning subgraph problem. Degree-based matching problems are of the form:

\hat{E}=argmax_{E′⊂E}Σ_{(u,v)εE′}w(u,v)+Σ_{vεV}ψᵥ(deg(v,E′)). (8)

The function deg(v, E) indicates the number of neighbors for node v in edge set E′. This class of problems contains all feasible DCS problems, since any DCS problem can be solved by defining appropriate ψ degree functions that return zero for all feasible degrees and negative infinity for all infeasible degrees. However, even though DCS is subsumed by degree-based matching, for concave degree functions ψ, degree-based matching is no harder than DCS.

In instances where the degree preference functions ψ are concave, a procedure reduces degree-based matching to b-matching on an augmented graph. Since the ψ functions need only be defined at valid degree inputs, a concave ψ function can be defined as a function satisfying:

ψᵥ(d)−ψᵥ(d−1)≧ψᵥ(d+1)−ψᵥ(d), ∀dε [symbol] ,1≦d≦n(v)−1, (9)

where n(v) is the original degree deg(v, E). I.e., for increasing valid inputs, the change in value of a concave function decreases.

The procedure for solving degree-based matching first augments the original graph with auxiliary nodes, where edges between original nodes and auxiliary nodes are set such that their total weights are equivalent to the ψ degree functions. Then it solves a maximum weight b-matching problem on the augmented graph.

The optimization algorithm for degree-based matching is as follows:
1. Input weighted graph G={V, E, w}, degree preferences {ψᵥ|vεV}, and maximum weight b-matching solver
2. Create auxiliary nodes \tilde{V}={(\tilde{v}₁, . . . , \tilde{v}ₙ} w_{aug}←w E_{aug}←EvεVd from 1 to n(v)
3. E_{aug}←E_{aug}∪{(v, \tilde{v}_{d})}
4. w_{aug}(v, \tilde{v}_{d})←ψᵥ(d−1)−ψᵥ(d)
5. G_{aug}←{V∪\tilde{V}, E_{aug}, w_{aug}}
6. Ê_{aug}←b-matching (G_{aug})
7. Ê←{(u, v)|(u, v)εÊ_{aug} [symbol] u, vεV}Ê
The augmented graph G_{aug}, contains a copy of the original graph G as well as a set \tilde{V} of additional auxiliary nodes. An auxiliary node is created for each possible nonzero degree in the graph, which for node v is all integers in the range [1, n(v)]. The augmented graph thus contains at most |V|−1 auxiliary nodes. Each original node vεV is connected to auxiliary nodes {\tilde{v}_{d}|1≦d≦n(v)} in augmented graph G_{aug}. This construction creates graph G_{aug}=(V_{aug}, E_{aug}, w_{aug}), where:

\tilde{V}={\tilde{v}₁, . . . ,\tilde{v}ₙ},V_{aug}=V∪\tilde{V},E_{aug}=E∪{(v,\tilde{v}_{d})|1≦d≦n(v),vεV}. (10)

The original edge weights in G_{aug} retain their original values, i.e., for uεV and vεV, w_{aug}(u, v)=w(u, v), and the weight between original node v and auxiliary node \tilde{v}ε\tilde{V} for 1≦d≦n(v) is:

w_{aug}(v,\tilde{v}_{d})=ψᵥ(d−1)−ψᵥ(d) (11)

i.e., the weight of the d'th auxiliary edge is the change in preference from degree d−1 to degree d. Consequently, while the ψᵥ functions have outputs for ψᵥ(0), there are no auxiliary nodes labeled \tilde{v}₀ associated with that setting (the value ψᵥ(0) is used to define the weight of edge (v, \tilde{v}₁)). The weights w_{aug}(v, \tilde{v}_{d}) are monotonically non-decreasing with respect to the index d due to the concavity of the ψᵥ functions. This is seen by substituting the auxiliary weight formula from Equation (10) for the concavity definition from Equation (9),

ψᵥ(d)−ψᵥ(d−1)≧ψᵥ(d+1)−ψᵥ(d) (12)

−w_{aug}(v,\tilde{v}_{d})≧−w_{aug}(v,\tilde{v}_{d+1}) (13)

w_{aug}(v,\tilde{v}_{d})≧w_{aug}(v,\tilde{v}_{d+1}). (14)

This non-decreasing quality is important to the correctness of the reduction to b-matching. The optimization over edges in G_{aug} emulates the optimization over edges in G according to Equation (8). The degree constraints in the augmented problem require each (original) node v to have exactly n(v) neighbors (including any connected auxiliary nodes) and auxiliary nodes have no degree constraints. The augmented problem is:

\hat{E_{aug}}=argmax_{E}_{_{aug}}_{′⊂E}_{_{aug}}Σ_{(u,v)εE}_{_{aug}}_{′},w_{aug}(u,v)s·t·deg(v,E_{aug}′)=n(v),∀vεV. (15)

The quantity n(v) in Equation (10) is the count of neighbors in the original graph. In the augmented objective, the solver is free to choose any graph structure in the original graph, but is required to maximally select auxiliary edges using its remaining free edges for each node. As the degree of a node with respect to its original neighbors changes, its auxiliary degree must change accordingly. Setting the auxiliary edge weights as described above makes that change equivalent to that of the original degree preference functions.

For example, given graph G={V, E, w}, where w(u, v) [symbol] [symbol] for each edge (u, v)εE, and concave degree preference functions ψᵥ(d) [symbol] [symbol] for each node vεV, for any subset of edges E′⊂E:

$${\sum }_{( u , v ) ∈ {E}^{′}} w ( u , v ) + {\sum }_{v ∈ V} {ψ}_{v} ( deg ( v , {E}^{′} ) ) + δ = {max}_{{E}_{{aug}^{′}} ⋂ E = {E}^{′} , {E}_{{aug}^{′}} ⊆ {E}_{aug}} {\sum }_{( u , v ) ∈ {E}_{{aug}^{′}}} {w}_{λ} ( u , v ) \\ s . t . deg ( v , {E}_{{aug}^{′}} ) = N ( v ) , ∀ v ∈ V , \qquad ( 16 )$$

where δ is a fixed constant independent of E′.

Consider the edges E_{aug}′∩E. The weights of possible edges in this intersection are the original weights from function w, and the restriction that E_{aug}′∩E=E′ means these edge sets are identical and therefore the total weights of w and w_{λ} over these edges are equal. What remains is to confirm that the total of the ψ degree preference values agree with the weights of the remaining edges in Ê_{aug}\E, which are edges between original nodes and auxiliary nodes. The augmented problem's degree constraints require each original node in G_{aug} to have degree equal to the original neighborhood size n(v). By construction, each node v has 2n(v) available edges from which to choose: n(v) edges from the original graph and n(v) edges to auxiliary nodes. Moreover, if v selects d original edges, it must maximally select n(v)−d auxiliary edges. Since the auxiliary edges are constructed such that their weights are non-decreasing, the maximum n(v)−d auxiliary edges connect to the last n(v)−d auxiliary nodes, namely auxiliary nodes \tilde{v}_{d+1} through \tilde{v}ₙ₍ᵥ₎. For this to hold, the change in a ψᵥ preference function value should equal the change in the maximum weight auxiliary edge choice. Formally, the change in weight when node v changes its degree from d to d′ is:

Σ_{j=d+1}^{n(v)}w(v,\tilde{v}ⱼ)−Σ_{j=d′+1}^{n(v)}w(v,\tilde{v}ⱼ) [symbol] ψᵥ(d)−ψᵥ(d′). (17)

Terms in the summations cancel to show this equivalence. After substituting the definition of w(vᵢ, \tilde{v}_{d}) from Equation (11), the desired equality is revealed with some simple algebra, providing

$${\sum }_{j = d + 1}^{n ( v )} ( {ψ}_{v} ( j - 1 ) - {ψ}_{v} ( j ) ) - {\sum }_{{j}^{′} = {d}^{′} + 1}^{n ( v )} ( {ψ}_{v} ( {j}^{′} - 1 ) - {ψ}_{v} ( {j}^{′} ) ) = {\sum }_{j = d}^{n ( v ) - 1} {ψ}_{v} ( j ) - {\sum }_{j = d + 1}^{n ( v )} {ψ}_{v} ( j ) - {\sum }_{{j}^{′} = {d}^{′}}^{n ( v ) - 1} {ψ}_{v} ( {j}^{′} ) + {\sum }_{{j}^{′} = {d}^{′} + 1}^{n ( v )} {ψ}_{v} ( {j}^{′} ) = {ψ}_{v} ( d ) - {ψ}_{v} ( {d}^{′} ) . \qquad ( 18 )$$

This means the original objective value for Equation (8) and the weight of the augmented graph change by the same value for different spanning subgraphs of G. Hence, the original objective and the total edge weight of the augmented subgraph differ only by a constant.

The total edge weight of the maximum weight subgraph Ê_{aug} of augmented graph G_{aug}, subject to original nodes having degrees equal to their original neighborhood sizes, differs from the original objective value, which is the total edge weight plus degree preference functions ψᵢ, by a fixed additive constant. Abstracting a b-matching solver, the algorithm for maximizing objective function (7) is summarized in Table 2.

TABLE 2
Example of mapping a degree dependent problem to a hard-constrained
b-matching. From left to right, top to bottom: the original weight matrix 1,
original degree preferences 1, both of which are used to construct the
augmented weight matrix 1, which is pruned to an augmented b-matching
1. From the augmented b-matching output, the solution 1 is obtained by
truncating the auxiliary nodes. The resulting degrees of the nodes 1
correlate with the original degree preferences.

| | |
|---|---|
| [Original weight matrix] | [Degree preferences] |
| [Augmented weight matrix] | [Augmented b-matching] |
| [Solution] | [Solution degrees] |

(c) K-Nearest Neighbors, Directed and Undirected b-Matching and Degree-Constrained Subgraph, and ε-Neighborhood Thresholding

The class of problems representable with concave degree preference functions includes k-nearest neighbors, directed and undirected b-matching and degree-constrained subgraph, and ε-neighborhood thresholding. It is useful to consider how to model directed degree constraints in the problem setting, which is formulated for undirected graphs. Directed problems are represented by duplicating the graph into two bipartitions, each containing copies of the original nodes. One partition represents the out-edges and the other partition represents the in-edges.

The k-nearest neighbor subgraph problem finds, for each node, its k nearest neighbors according to some affinity values, which often are computed from a distance metric. The k-nearest neighbor problem differs from b-matching in that k-nearest neighbor graphs are directed. Each node greedily connects to its k closest nodes, regardless of how many connections that neighbor already has. Using the duplicated-node construction, the k-nearest neighbors degree constraints are representable by concave preference functions which return zero for in-degree k on all nodes and negative-infinity for every other degree. All out-degree preferences are uniform at zero, and the weights of the edges are set to node similarity (or negative distance). Thus, the degree preference functions require in-degree of k but have no influence over out-degree.

Similar degree functions easily encode b-matching in terms of concave preference functions. For example, perfect b-matching constraints are encoded with degree preference functions that again output zero at each node's required degree bᵥ and negative infinity for all other degrees. More generally, degree-constrained subgraph is encoded by having ψ functions output zero for the range of allowed degrees and negative infinity otherwise.

Finally, ε-neighborhood thresholding, in which nodes are connected to all neighbors within distance ε, is encoded by a linear penalty on all nodes' degrees. Setting each ψᵥ function for all nodes to ψᵥ(d)==εd, the maximum subgraph includes any edge with weight greater than ε. This is because the change to the objective value when an edge is added is the weight of the edge plus a single penalty ε for increasing the degree by one. Therefore, any edges whose weight is greater than the penalty will add to the objective and will be active at the maximum.

(2) Performing b-Matching Using Maximum Likelihood Estimation or Belief Propagation

(a) Degree-Based Matching as Maximum Likelihood Estimation

The degree-based matching objective may be interpreted as a probability distribution over graph structures by exponentiating the objective function. The resulting log-probability distribution is:

log Pr(E′)=Σ_{(u,v)εE′}W(u,v)+Σ_{vεV}ψᵥ(deg(v,E′))−log Z(w,ψ), (19)

where the partition function Z is:

Z(w,ψ)=Σ_{E′}exp(Σ_{(u,v)εE′}w(u,v)+Σ_{vεV}ψᵥ(deg(v,E′))). (20)

Computation of this partition function is #P-complete, and thus marginal inference is intractable. In the case that the degree preferences are given but the weights are determined by some observed data X, then the probability may be interpreted as a maximum a posteriori (MAP) estimation. If the observed data associated with each edge is conditionally independent given the presence or non-presence of the edge, the weight is equivalent to the gain in log-likelihood as the edge variable is changed from not present to present:

$$w ( u , v ) = log \frac{Pr ( X \vert ( u , v ) ∈ {E}^{′} )}{Pr ( X \vert ( u , v ) ∉ {E}^{′} )} . \qquad ( 21 )$$

Thus, the total likelihood of data X is proportional to the exponentiated weight of all included edges:

Pr(X|E′)∝exp(Σ_{(u,v)εE′w}(u,v)). (22)

In this setting, the degree preferences act as a prior probability over edge structures:

Pr(E′)∝exp(Σ_{vεV}ψᵥ(deg(v,E′))). (23)

Combining the data likelihood and the edge prior, the resulting optimization is equivalent to the standard MAP inference formulation:

\hat{E}=argmax_{E′}Pr(X|E′)Pr(E′). (24)

Using these interpretations may guide model selection in practice. For example, deciding what function to use to determine the weight between nodes may benefit from the log-likelihood ratio interpretation. Treating the optimization as a MAP inference allows the choice of degree priors to filter the observed data from unlikely measurements.

The optimization problem referred to here as degree-based matching is a general form of degree-based subgraph estimation. The efficient solver described above reduces the problem to a maximum weight b-matching on an augmented graph. Given the reduction, any polynomial-time b-matching solver will find the solution.

(b) Fast Belief Propagation for Maximum Weight b-Matching

The structure of the maximum weight b-matching problem lends itself to a natural representation as a Markov random field, in which random variables represent the matching assignments and functions of these random variables represent both the constraints and the weights. Representing the problem as a probabilistic system means probabilistic inference techniques that recover the most likely setting of the random variables also solve maximum weight b-matching.

The Max-Product Algorithm

In a pairwise Markov random field over variables {x₁, . . . , xₙ}, the log-probability of any state is:

log Pr(X)=ΣᵢΦᵢ(xᵢ)+ΣᵢⱼΨᵢⱼ(xᵢ,xⱼ)−log Z(Φ,Ψ), (25)

where Z(Φ, Ψ) is the normalizing partition function. The standard max-product update rules maintain a message vector mᵢⱼ from each variable xᵢ to variable xⱼ:

$${m}_{ij}^{t} ( {x}_{j} ) = {max}_{{x}_{l}} [ {Φ}_{i} ( {x}_{i} ) + {Ψ}_{ij} ( {x}_{i} , {x}_{j} ) + {\sum }_{k \neq j} {m}_{ki}^{t - 1} ( {x}_{i} ) ] , \qquad ( 26 )$$

which combines incoming messages from all nodes except the message receiver with its own local potentials to form outgoing messages. Given all incoming messages, the belief at iteration t for variable state xᵢ combines all incoming messages with the local potential:

B^{t}(xᵢ)=Φ(xᵢ)+Σⱼmⱼᵢ^{t-1}(xᵢ). (27)

Max-Product for b-Matching

In a node-based representation of b-matching, the b-matching is represented by variables {xᵥ|vεV}, the values of which represent the neighbors of v in the b-matching Ê. Let function S convert a node variable to its encoded neighbor-set, e.g., S(xᵥ_{₁})={v₇, v₈}. Since node v must have degree bᵥ, xᵥ has n(v)_{b}_{ᵥ} possible settings, each representing a possible set of bᵥ neighbors. Since likelihoods of independent events are multiplicative, the additive weights of a maximum weight b-matching problem are represented as log-potentials:

Φᵤ(xᵤ)=Σ_{vεS(x}_{ᵤ}₎w(u,v). (28)

These weight potentials are tied together by pairwise b-matching compatibility functions, which ensure the agreement between all nodes' variable states.

$${Ψ}_{uv} ( {x}_{u} , {x}_{v} ) = \{ \begin{matrix}0 & if both nodes connect ( v ∈ S ( {x}_{u} ) ) ( u ∈ S ( {x}_{v} ) ) \\ 0 & if neither node connects ( v ∉ S ( {x}_{u} ) ) ( u ∉ S ( {x}_{v} ) ) \\ - ∞ & otherwise ( {x}_{u} and {x}_{v} disagree )\end{matrix} \qquad ( 29 )$$

Using the defined potential functions Φ and the pairwise compatibility functions Ψ, the maximum weight b-matching objective is equivalent to finding the most likely state of variable set {xᵤ|uεV} for unnormalized log-likelihood:

Σ_{uεV}Φᵤ(xᵤ)+Σ_{u,vεV}Ψᵤᵥ(xᵤ,xᵥ). (30)

The standard max-product algorithm iteratively passes messages vectors between variables and computes beliefs, which are estimates of max-marginals. The standard update equations for beliefs B and messages mᵤ(xᵥ) from variable xᵤ to xᵥ are:

$${m}_{uv}^{t} ( {x}_{v} ) = {max}_{{x}_{u}} [ \begin{matrix}{Φ}_{u} ( {x}_{u} ) + {Ψ}_{uv} ( {x}_{u} , {x}_{v} ) + \\ {\sum }_{a ∈ V \backslash v} {m}_{au}^{t - 1} ( {x}_{u} )\end{matrix} ] , \\ {B}^{t} ( {x}_{u} ) = {Φ}_{u} ( {x}_{u} ) + {\sum }_{v ∈ V} {m}_{vu}^{t - 1} ( {x}_{u} ) . \qquad ( 31 )$$

To alleviate some notational clutter, define the message from a node to itself as a vector of all zeros.

In general, a cyclic graphical model like the one described above suffers from two possible problems: the messages may never converge, and they may converge to a state that is not the global optimum. A theorem that guarantees neither of these will occur in bipartite graphs and that the algorithm will converge to the true optimum in a bounded number of iterations is presented below. The convergence guarantee is then extended to apply toward maximum weight b-matchings on non-bipartite graphs whose LP relaxations are tight.

The bipartite convergence guarantee requires two preconditions: first, that the edge weights are bounded, and, second, that the optimum is unique. Let weight function w be overloaded such that, given an input edge set, it outputs the sum of edge weights, w(E)=Σ_{eεE}w(e). For input graph G=(V, E, w, b), let M(G) be the set of edge sets corresponding to valid b-matching solutions. The analysis considers the belief state of a particular node after some iteration of belief propagation.

The max-product belief of a node in a loopy graphical model after iteration t is known to be equivalent to the max-marginal of the node's unwrapped graph. The unwrapped graph is equivalent to the computation tree of messages passed during belief propagation, and is constructed by following the message propagation in reverse. Formally, the unwrapped graph Tᵥ=(V^{T}, E^{T}) of node vεV is rooted by a copy of v, denoted r. We denote this copying relationship with mapping function τ, which maps nodes in V^{r} to their corresponding nodes in V. E.g., τ(r)=v. The children of the root are copies of v's neighbors in G. Then, the children of each interior node uεV^{T} are the neighbors of τ(u) in G except the node corresponding to u's parent. The paths in an unwrapped graph of height h represent all possible non-backtracking walks of length h in G starting from root node v.

The non-backtracking, unwrapped graph construction is equivalent to the similarly non-backtracking message update rule, such that messages propagated from the leaves of the unwrapped graph to the root are the same messages passed during loopy belief propagation. Since, however, the unwrapped graph is a tree and contains no cycles, the beliefs for the root node after propagating messages upwards are the true max-marginals on the tree.

For the b-matching graphical model, this corresponds to a near-perfect maximum weight b-matching on the tree, where all nodes but the leaf nodes have their exact target degree. Using the unwrapped graph construction, the following two quantities are equivalent: the number of iterations of loopy belief propagation on G such that node v's belief for the optimal b-matching is guaranteed to exceed the belief for any suboptimal b-matching, and the height of tree Tᵥ such that the maximum weight b-matching on Tᵥ connects root node r to the corresponding neighbors of v in the maximum weight b-matching of G. Given bipartite input graph G=(V, E, w, b), such that a unique, optimal b-matching Ê has weight greater by constant ε than any other b-matching, i.e.:

$$ɛ \leq w ( \hat{E} ) - {max}_{{E}^{′} ∈ , {E}^{′} \neq \hat{E}} w ( {E}^{′} ) , \qquad ( 32 )$$

and all weights are bounded inclusively between wₘᵢₙ and wₘₐₓ, i.e.:

wₘᵢₙ≦w(e)≦wₘₐₓ,∀eεE, (33)

the maximum belief at iteration t for any node vεV indicates the corresponding neighbors in true optimum Ê when t=O(|V|). The convergence conditions are further relaxed to include any maximum weight b-matching problem for which the linear programming relaxation is tight.

Assuming that the linear programming relaxation of the b-matching problem on G has a unique, integer solution, and that the weights in G are bounded, the belief propagation converges to the optimal solution in O(|V|) iterations. The running time is dependent on the ε value for the input, and thus, the algorithm is not strongly polynomial. This dependence causes two scenarios on which belief propagation fails in practice. The first is when ε is zero, which happens when at least two b-matchings achieve the maximum weight, and the second is when ε is very small, in which case the number of iterations necessary for convergence is very large. In theory, adding random noise to the weights corrects the first scenario, but in practice, this tends to create the second scenario, in which the artificially nonzero ε is quite small.

(3) Message Simplification

(a) Simplifying the Update Rule

A simplified update rule is derived which compactly and exactly computes the standard max-product message updates by exploiting the fixed structure of the matching compatibility functions. In the standard max-product algorithm, each message between variables is a vector, with an entry representing each possible setting of the receiver variable.

In the b-matching model, however, each entry of these message-vectors is always one of two possible values, which, since the message vectors are scale-invariant, can be summarized as a ratio of the two values. Thus, with careful bookkeeping, all messages can be compressed to single belief scalars for each candidate edge. Updating an edge's belief-value is possible in time proportional to the number of candidate neighbors for the source node, again by exploiting the structure of the matching problem to circumvent the combinatorially large set of possible states for the source node's variable. The edge-based beliefs can then be further summarized per node by unrolling one level of message-passing recursion, resulting in only O(|V|) additional storage during belief propagation.

After various algebraic simplifications of the message update rules, the messages can be represented by a scalar along each possible edge. The messages are updated using a selection operation, which finds the k'th largest element of a set for some index k. For notational convenience, denote the selection operation over any set S as:

σₖ(S)=sεS where|{tεS|t≧s}|=k. (34)

Then the simplified message update is:

\hat{μ}ᵤᵥ=w(u,v)−σ_{b}_{ᵤ}({w(a,u)+\hat{μ}ₐᵤ|aεV\v}). (35)

A final algebraic manipulation allows elimination of the messages altogether, resulting in a direct belief update rule. Using the current simplified message from Equation (35), the belief for any state is:

B^{t}(xᵤ)=Σ_{vεS(x}_{ᵤ}₎w(u,v)+\hat{μ}ᵥᵤ^{t}, (36)

which is a purely additive combinatorial sum, and thus can be maximized by greedily choosing the bᵤ greatest values in {w(u, v)+\hat{μ}ᵤᵥ|vεV\u}. Each of these quantities acts as an edge-wise belief:

Bᵤᵥ^{t}=w(u,v)+\hat{μ}ᵥᵤ^{t}. (37)

Substituting the message update rule (35), the following simplifications are available:

Bᵤᵥ^{t}=w(u,v)+(w(v,u)−σ_{b}_{ᵥ}({w(a,v)+\hat{μ}ₐᵥ|aεV\u})) (38)

Since the problem parameterization handles an undirected graph, weights w(u, v) and w(v, u) are equal, and a constant doubling can be dropped. Furthermore, replacing weight w(a, v) with w(v, a) inside the selection makes the selection over edge-wise beliefs themselves, leaving the simplified belief update rule:

Bᵤᵥ^{t}=w(u,v)−σ_{b}_{ᵥ}({Bᵥₐ^{t-1}|aεV\u}). (39)

(b) Unrolling the Recursion of the Belief Update Rule

Additionally to the simplifications provided so far, the update rules still contain enough structure to allow even further scalability improvements, described in detail below. By unrolling the recursion of the belief update rule, storing full beliefs becomes unnecessary. Instead, all that must be stored are the selected beliefs, because the selection operation in Equation (39) only weakly depends on sender node u. That is, the selection operation is over all nodes except u, which means the selected value will be either the bᵥ'th or the (bᵥ+1)'th greatest element:

σ_{b}_{ᵥ}({Bᵥₐ^{t-1}|aεV\u})ε{σ_{b}_{ᵥ}({Bᵥₐ^{t-1}|aεV}),σ_{b}_{ᵥ}₊₁({Bᵥₐ^{t-1}|aεV})}. (40)

Thus, once each row of the belief matrix B is updated, these two selected values can be computed and stored, and the rest of the row can be deleted from memory. Any further reference to B is therefore abstract, as it is never instantiated in practice. Entries of the belief matrix can be computed in an online manner from the stored selected value. Let αᵥ be the negation of the bᵥ'th selection and βᵥ be that of the (bᵥ+1)'th selection. Then the update rules for these parameters are:

αᵥ^{t}=−σ_{b}_{ᵥ}({Bᵥₐ^{t-1}|aεV}), βᵥ^{t}=−σ_{b}_{ᵥ}₊₁({Bᵥₐ^{t-1}|aεV}), (41)

and the resulting belief lookup rule is:

$${B}_{uv}^{t} = w ( u , v ) + ( \begin{matrix}{α}_{v}^{t} & if ( v , u ) ∉ {\hat{E}}^{t - 1} \\ {β}_{v}^{t} & otherwise\end{matrix} \qquad ( 42 )$$

At the end of each iteration, the current estimate of P is:

Ê^{t}={(u,v)|Bᵤᵥ^{t-1}≧αᵥ^{t}}, (43)

which is computed when the α and β values are updated in Equation (41). When this estimate is a valid b-matching, i.e., when all nodes have their target degrees, the algorithm has converged to the solution. The algorithm can be viewed as simply computing each row of the belief matrix and performing the selections on that row and is summarized as follows: Algorithm 1: Belief propagation for b-matching. Computes the maximum weight b-matching:

| | |
|---|---|
| 1: | αᵥ⁰ ← 0, ∀v ε V |
| 2: | βᵥ⁰ ← 0, ∀v ε V |
| 3: | \hat{Ε}⁰ = |
| 4: | t ← 1 |
| 5: | while not converged do |
| 6: | for all u ε V do |
| 7: | αᵤ^{t} ← −σ_{b}_{ᵤ}({B_{uα}^{t-1}\|a ε V}) |
| 8: | βᵤ^{t} ← −σ_{b}_{ᵤ}₊₁({B_{uα}^{t-1}\|a ε V}) |
| 9: | for all \hat{Ε}^{t} = {(u,v)\|Bᵤᵥ^{t-1} ≧ αᵤ^{t}} do |
| 10: | \hat{Ε}^{t} = {(u,v)\|Bᵤᵥ^{t-1} ≧ αᵤ^{t}} |
| 11: | end for |
| 12: | end for |
| 13: | delete α^{t-1} and β^{t-1}from memory |
| 14: | t ← t + 1 |
| 15: | end while. |

Using these simplifications, the running time per iteration is primarily dependent on the time to perform the selection operation. In the worst case, the best known algorithm is O(N) time to perform select for any k.

(4) Fast Message Updates Via Sufficient Selection

Another enhancement aims to reduce the running time of each iteration by exploiting the nature of the quantities being selected. In particular, the key observation is that each belief is a sum of two quantities: a weight and an α or β value. These quantities can be sorted in advance, outside of the inner (row-wise) loop of the algorithm, and the selection operation can be performed without searching over the entire row, significantly reducing the amount of work necessary. This is done by testing a stopping criterion that guarantees no further belief lookups are necessary. Some minor difficulties could arise, however, when sorting each component, so the algorithm does not directly apply as-is. First, the weights cannot always be fully sorted. In general, storing full order information for each weight between all pairs of nodes requires quadratic space, which is impossible with larger data sets. Thus, the proposed algorithm instead stores a cache of the heaviest weights for each node. In some special cases, such as when the weights are a function of Euclidean distance, data structures such as kd-trees can be used to implicitly store the sorted weights. This construction can provide one possible variant to Algorithm 1.

Second, the α-β values require careful sorting, because the true belief updates mostly include αt terms but a few β^{t} terms. Specifically, the indices that index the greatest bⱼ elements of the row should use β^{t}. One way to handle this technicality is to first compute the sort-order of the αt terms and, on each row, correct the ordering using a binary search-like strategy for each index in the selected indices. This method is technically a logarithmic time procedure, but requires some extra indexing logic that creates undesirable constant time penalties.

Another approach, which is much simpler to implement and does not require extra indexing logic, is to use the sort-order of the β^{t}'s and adjust the stopping criterion to account for the possibility of unseen α^{t} values. Since the weights do not change during belief propagation, at initialization, the algorithm computes index cache Iε [symbol] ^{(m+n)×c} of cache size c, which is a parameter set by the user, where entry Iᵢₖ is the index of the k'th largest weight connected to node xᵢ and, for u=Iᵢₖ,

W(xᵢ,xᵤ)=σₖ({W(xᵢ,xⱼ)|j}). (44)

At the end of each iteration, the β^{t} values are similarly sorted and stored in index vector

eε [symbol] ^{m+n}, where, for v=eₖ, entry βᵥ^{t}=σₖ(βⱼ^{t}|j}). (45)

The selection operation is then computed by checking the beliefs corresponding to the sorted weight and β indices. At each step, a set S of the greatest bⱼ+1 beliefs seen so far are maintained. These provide tight lower bounds on the true α-β values. At each stage of this procedure, the current estimates for αⱼ^{t} and βⱼ^{t} are:

\tilde{α}ⱼ^{t}←σ_{b}_{ⱼ}(S), and \tilde{β}ⱼ_{ₜ}←min(S). (46)

Incrementally scan the beliefs for both index lists (I)ⱼ and e, computing for incrementing index k, Bᵢₗ_{ᵢₖ} and Bᵢₑ_{ₖ}. Each of these computed beliefs is compared to the beliefs in set S and if any member of S is less than the new belief the new belief replaces the minimum value in S. This maintains S as the set of the greatest bⱼ+1 elements seen so far.

At each stage, the greatest possible unseen belief is bound as the sum of the least weight seen so far from the sorted weight cache and the least β value so far from the β cache. Once the estimate \tilde{β}ⱼ^{t} is less than or equal to this sum, the algorithm can exit because further comparisons are unnecessary. Algorithm 2 summarizes the sufficient selection procedure.

Algorithm 2: Sufficient Selection. Given sort-order of β^{t} values and partial sort-order of weights, selects the bⱼ'th and bⱼ+1'th greatest beliefs of row j.

| | |
|---|---|
| 1: | k ← 1 |
| 2: | bound ← ∞ |
| 3: | S ← |
| 4: | \tilde{α}ⱼ^{t} ← −∞ |
| 5: | \tilde{β}ⱼ^{t} ← −∞ |
| 6: | \tilde{β}ⱼ^{t} < bound do |
| 7: | if k ≦ c then |
| 8: | u ← Iⱼₖ |
| 9: | if u ← Iⱼₖ (u is unvisited and (Bⱼᵤ^{t-1} > min(S)) then |
| 10: | S ← (S\min(S)) ∪ Bⱼᵤ^{t-1} |
| 11: | end if |
| 12: | end if |
| 13: | v ← eₖ |
| 14: | if v is unvisited and (Bⱼᵥ^{t-1} > min(S)) then |
| 15: | S ← (S\min(S)) ∪ Bⱼᵥ^{t-1} |
| 16: | end if |
| 17: | bound ← W(xⱼ, xᵤ) + βᵥ^{t-1} |
| 18: | \tilde{α}ⱼ^{t} ← σ_{b}_{ⱼ}(S) |
| 19: | \tilde{β}ⱼ^{t} ← σ_{b}_{ⱼ}₊₁(S) |
| 20: | k ← k + 1 |
| 21: | end while |
| 22: | αⱼ^{t} ← \tilde{α}ⱼ^{t} |
| 23: | βⱼ^{t} ← \tilde{β}ⱼ^{t} |

Thus, the algorithm will never stop too early. However, the running time of the selection operation depends on how early the stopping criterion is detected. In the worst case, the process examines every entry of the row, with some overhead checking for repeat comparisons. For random orderings of each dimension (and no truncated cache size), the expected number of belief comparisons necessary is O(\sqrt{N}) to find the maximum, where N=m+n=|V|. The selection is computable with O(\sqrt{bN}) expected comparisons.

However, for problems where the orderings of each dimension are negatively correlated, the running time can be worse. In the case of b-matching, the orderings of the beliefs and potentials are in fact negatively correlated, but in a weak manner. We first establish the expected performance of the sufficient selection algorithm under the assumption of randomly ordered β values. Considering the element-wise sum of two real-valued vectors \vec{w} and \vec{β} of length N with independently random sort orders, the expected number of elements that must be compared to compute the selection of the b'th greatest entry σ_{b} ({wᵢ+βᵢ|i}) is \sqrt{bN}.

The sufficient selection algorithm can be equivalently viewed as checking element-wise sums in the sort orders of the \vec{w} and \vec{β} vectors, and growing a set of k indices that have been examined. The algorithm can stop once it has seen b entries that are in the first k of both sort orders. First consider the algorithm once it has examined k indices of each vector, and derive the expected number of entries that will be in both sets of k greatest entries. Since the sort orders of each set are random, the problem can be posed as a simple sampling scenario.

Without loss of generality, consider the set of indices that correspond to the greatest k entries in \vec{w}. Examining the greatest k elements of \vec{β} equivalent to randomly sampling k indices from 1 to N without replacement. Thus, the probability of any of the k greatest entries of \vec{β} being sampled is k/N. Since there are k of these, the expected number of sampled entries that are in the greatest k entries of both vectors is k²/N.

A determination of the number of entries the algorithm must examine to have an expected b entries in the top k is done next. Solving the equation b=k²/N for k yields that when k=\sqrt{bN}, the algorithm will in the expected case observe b entries in the top k of both lists, exactly the sufficient selection stopping criterion.

Applying the estimated running time to analysis of the full matching algorithm, the following arguments describe the scaling behavior of the algorithm. Assuming the β messages and the weight potentials are randomly, independently ordered, and a constant b, then the total running time for each iteration of belief propagation for b-matching with sufficient selection is O(N^{1.5}), and the total running time to solve b-matching is O(N^{2.5}).

When nodes represent actual objects or entities and the weights are determined by a function between nodes, the weight values have dependencies and are therefore not completely randomly ordered. Furthermore, the β values change during belief propagation according to rules that depend on the weights, and in some cases can cause the selection time to grow to O(N). Nevertheless, in many sampling settings and real data generating processes, the weights are random enough and the messages behave well enough that sufficient selection yields significant speed improvements.

The space requirement for this algorithm has also been reduced from the O(N²) beliefs to O(N) storage for the α and β values of each row. Naturally, this improvement is most beneficial in settings where the weights are computable from an efficient function, whereas if the weights are arbitrary, they must be explicitly stored at the cost of O(N²) memory. In most machine learning applications, however, the weights are computed from functions of node descriptor pairs, such as Euclidean distance between vectors or kernel values. In these applications, the algorithm needs only to store the node descriptors, the α and β values and, during the computation, O(N) beliefs (which can be immediately deleted before computing the next row). The weight cache adds O(cN) space, where c is a user-selected constant.

The space reduction is also significant for the purposes of parallelization. The computation of belief propagation is easy to parallelize, but the communication costs between processors can be prohibitive. With the described algorithm, each computer in a cluster stores only a copy of the node descriptors and the current α and β values. At each iteration, the cluster must share the 2N updated α and β values. This is in contrast to previous formulations where O(N²) messages or beliefs needed to be transmitted between computers at each iteration for full parallelization. Thus, when it is possible to provide each computer with a copy of the node descriptor data, an easy parallelization scheme is to split the row updates between cluster computers at each iteration. At each iteration, each node independently updates its beliefs by running the above described algorithms (Algorithms 1 and 2) given the previous iterations' α and β vectors. This process is easily parallelizable by delegating the selection operations for nodes to different processors. Using this parallelization scheme, each computer stores the weights for the nodes it is responsible for (or the node descriptors), and a central computer collects and distributes the computed α and β vectors. At each iteration, the central computer sends the latest belief vectors to each worker, as well as the current b-matching assignment for the nodes each worker is responsible for. After each worker computes its new belief values, it sends these new belief values and the new b-matching assignments back to the central computer. The communication cost is significantly reduced by the unrolled recursion, resulting in the central computer sending an O(N) vector to each node at each iteration and receiving O(1) data back after computation.

To avoid centralizing the process, each computer can store all of the node descriptors (or only the weights associated with assigned nodes) as well as belief vectors, sending and receiving updates from all other nodes at each iteration. In this case, each node sends O(1) data to each other node at each iteration, which results in an overall bandwidth usage of O(N²) per iteration, the same as in the centralized version.

The operation proceeds based on whether the termination condition has been reached as indicated at 112. The termination condition can be defined as reaching a steady state with respect to message updating. The steady state can be defined as no further message updates being sent or an amount of update message being sent that is below a certain threshold.

Alternatively, the termination condition can be defined in terms of a number of iterations of message updating or a number of messages sent (either an aggregate number or a number per node). In another alternative, the termination condition can be defined as the elapsing of a predetermined period of time. If the termination condition has been reached, processing continues with the selection, for an input node, of a predetermined number of supplier nodes or a predetermined number of customer nodes. Otherwise processing returns to the operation indicated at 110 and discussed above.

The nodes selected are matched based on updated belief values. For example, in a b-matching problem, the b nodes having the highest belief values with respect to an input node are selected. Ties can be handled in a number of ways including by using a “coin toss” to select between tying nodes, or, alternatively or in addition, a small random value can be added to the weight or profit matrix value for each edge so that no two nodes are likely to tie. The selected nodes can be provided as output to another process or system.

At 112, an output operation is performed. For example, a result graph or matrix, or a portion of a result graph or matrix can be provided to another module within the same system, provided to another system or provided to a user or operator for use in another process. Processing continues to 114 where processing ends. It will be appreciated that 104-112 can be repeated in whole or in part in order to accomplish a contemplated matching using degree distribution.

FIG. 1B shows a chart of a method 101 for b-matching using sufficient selection belief propagation. Processing begins at 120 and continues to 122.

At 122, a system obtains an input graph and weight matrix. Processing continues to 124.

At 124, the system updates belief values using belief propagation. A simplified update rule, as described above, can be used to speed up the belief propagation processing. Processing continues to 126.

At 126, the system sorts the belief values. For example, each belief is a sum of two quantities: a weight and an α or β value. These quantities can be sorted in advance, outside of the inner (row-wise) loop of the belief propagation algorithm, and the selection operation can be performed without searching over the entire row, significantly reducing the amount of work necessary. Processing continues to 128.

At 128, the system selects a portion of sorted belief values. As mentioned above, the bᵥ'th and the (bᵥ+1)'th values can be stored (see, e.g., Equation 40 above). Processing continues to 130.

At 130, the selected belief values are stored. For example, once each row of the belief matrix is updated, the two selected values can be computed and stored, and the rest of the row can be deleted from memory. Processing continues to 132.

At 132, the system determines whether a termination condition has been reached. The termination condition can be a specific number of iterations performed or as a steady state in the belief values. If a termination condition has been reached, processing continues to 134. If not, processing returns to 124.

At 134, a downstream operation or output is performed. Processing continues to 136, where processing ends.

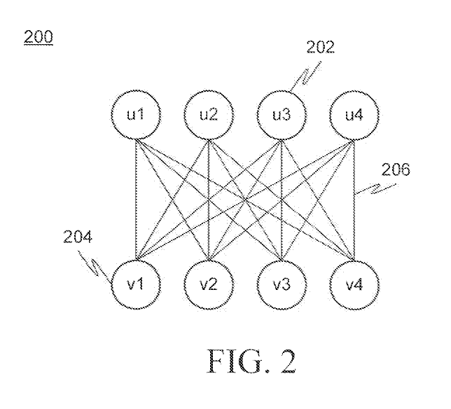

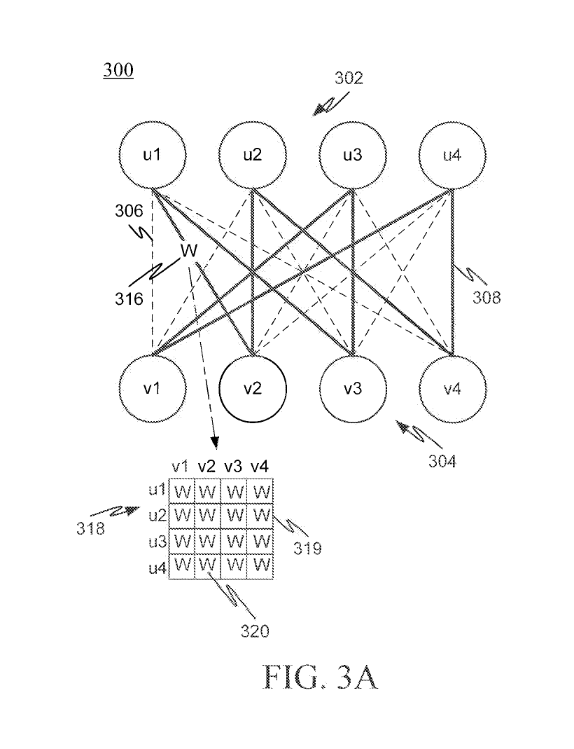

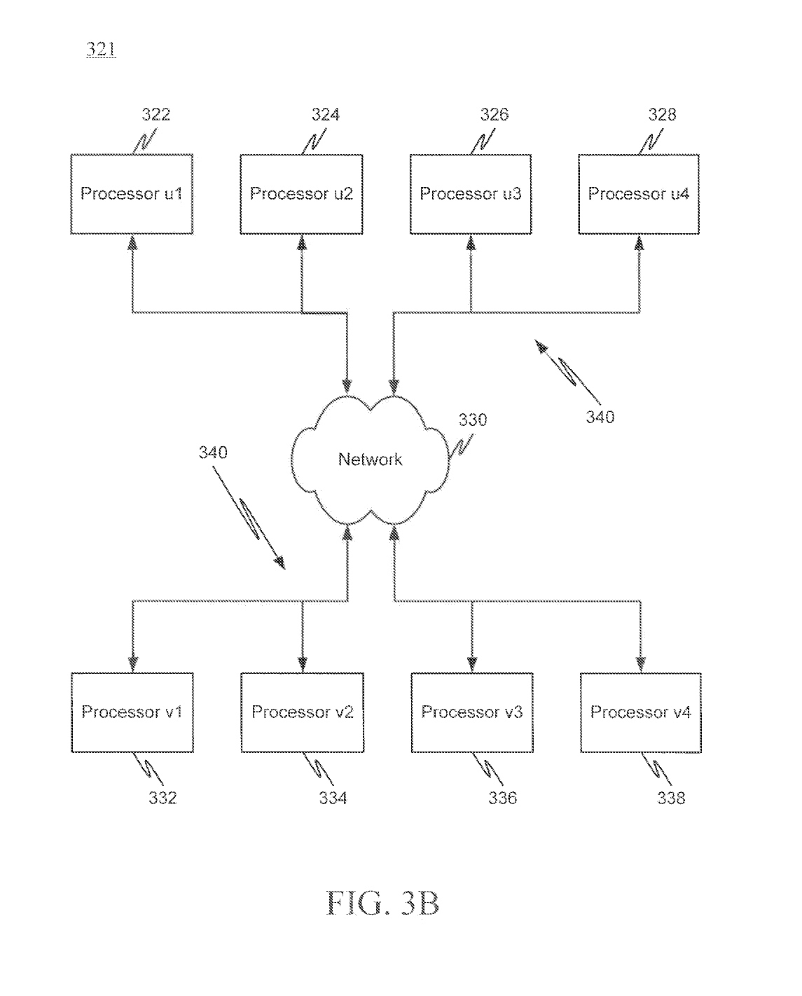

FIG. 2 and FIG. 3A are schematic diagrams of a bipartite dense maximum weight perfect b-matching problem represented as a bipartite graph. FIG. 2 shows unmatched elements, while FIG. 3A shows matched elements, unmatched elements and a weight matrix.

FIG. 2 shows a bipartite graph 200 having a first group of nodes 202 (u1-u4) matched to a second group of nodes 204 (v1-v4) potentially connected by edges 206.

In FIG. 3A, a bipartite graph 300 shows a first group of nodes 302 (u1-u4) matched to a second group of nodes 304 (v1-v4). The first group may represent a first group of entities or things such as goods, people, or resources and the second group may represent a second group of entities or things such as consumers, people, or resource users. The nature of the objects or entities that can make up these first and second groups are numerous as should be clear from the instant disclosure, but a common feature in most embodiments is that entities of the first group are to be matched to entities of the second group as a part of some kind of a transaction and the precise matching may correspond to some kind of aggregate value such as maximum total revenue. The matching problem posed by the context of the particular first and second groups and the aggregate value sought may also involve constraints such as the number of first group of things that are to be matched to a given second group of thing. Groups could be distinguished by any classification and groupings are not limited by the examples given.

In FIG. 3A, dashed lines (e.g., 306) represent possible edges and solid lines (e.g., 308) represent b-matched edges. By b-matched, it is meant that the problem illustrated results in a desired b matches between each of the first group of things to one or more second group of things. In the case shown on the bipartite graph 300, b=2 for each node of groups 302 and 304, so that each node 302 or 304 is connected to two other nodes 304 or 302 with matched edges 308.

Typically, the information representing the potential assignment as indicated by all of the lines 306 and 308 can be supplemented with additional information, generally, weights, which indicate something about the value or cost associated with making each assignment. Here a weight W value of an edge is represented at 316. This weight information may serve as a basis for selecting an assignment that provides some optimum or provides a basis for discriminating the goodness of one assignment scheme versus another. The additional information may be represented in the form of any suitable data structure to store a weight for each edge, such as a weight matrix 318 with each row corresponding to a member of the first group and each column corresponding to a member of the second group with each cell 320 at an intersections indicating the respective weight of an edge connecting each pair of members.

The weight matrix 318 represents different weights for each combination of buyer and seller.

The problem of matching of members of one group to another can be described in terms of a bipartite graph. Given a bipartite graph (which can be represented by 300) and associated weight data, a method can be used to perform a matching based on belief propagation. Here the example of a situation where it is desired to match suppliers with customers will be used to illustrate the method. One or more computers may be provided with information defining supplier and customers, which are referred here to as “nodes” which information may be considered to define a bipartite graph 300. Each supplier node (u 302 or v 304) is connected to a customer node (v 304 or u 302) by an edge 308 so the one or more computers is supplied with the potential edges 308 of all the nodes 302, 304 mapping from a supplier node to a customer node. The one or more computers are also provided with access to weight data, for example a matrix 318 with a weight value 319 for each edge of the bipartite graph data structure. The process executed by the one or more computers is such that information is recorded and updated respective of each node, such that a subprocess is performed for each node that communicates with other nodes. In this example, the weight data may be total cost of goods and the optimum matching would coincide with maximum exchange of revenue between buyers and sellers.

Referring now also to FIG. 3B, according to this and other embodiments, the matching problem may be distributed in a system 321 among multiple processors 322-328 and 332-338 communicating over a network 330 such that each can send and receive messages via wired or wireless links being depicted figuratively as connecting lines 340. For the present example, each node shown in FIG. 3A may correspond to a respective node processor 322-328 and 332-338 in FIG. 3B. An alternative would be that each processor would correspond to multiple nodes, but for the sake of discussion, the case where there is a separate processor for each node will be assumed. In such a case only a portion of the weight data in the weight matrix 318 may be provided to each supplier node processor (322-328), the portion being sufficient to indicate the weights of the edges that connect each supplier to all its potential customers (e.g., all the other customers). Similarly, only a portion of the weight matrix 318 may be provided to each customer node processor (332-338) indicating the weights of the edges that connect the customer to all its potential suppliers. The node processors can access the respective weight information on common (e.g. central) or distributed data stores (e.g., respective of each node or community of node processors).

FIG. 3B is a diagram of an arrangement of distributed processors for generalized matching using belief propagation according to some embodiments of the disclosed subject matter. In particular, in this example, a first group of node processors (322-328) correspond to nodes u1-u4 of the graph shown in FIG. 3A, respectively. A second group of node processors (332-338) correspond to nodes v1-v4 of the graph shown in FIG. 3A, respectively. Each of the node processors (322-328 and 332-338) are independently coupled to a network 330 (e.g., the Internet, a local area network, wide area network, wireless network, virtual private network, custom network, bus, backplane, or the like). By being interconnected through the network 330, each of the node processors (322-328 and 332-338) can communicate with the others and send/receive messages according to the belief propagation method described. Also, each of the node processors (322-328 and 332-338) can be queried independently for its b-matched list generated by the belief propagation method described below. Not only can each node be independently queried, but each node can arrive at its optimal b-matched solution without requiring knowledge of the other nodes' solutions (i.e., the belief propagation method is “privacy protecting” with respect to each node).

The solutions for each node can be aggregated in a central data storage location or may be retained individually at each node, or grouped according to a criterion (e.g., grouping all supplier matches into a list and all customer matches into another list).

The network 330 can be a network such as the Internet, a local area network (LAN), a wide area network (WAN), a virtual private network (VPN), a direct connection network (or point-to-point), or the like. In general, the network can include one or more now known or later developed technologies for communicating information that would be suitable for performing the functions described above. The selection of network components and technologies can depend on a contemplated embodiment.

In FIG. 3B, one processor is shown for each node for clarity and simplicity of illustrating and describing features of an embodiment. It will be appreciated that each processor may perform the belief propagation method for more than one node.

Not shown in FIG. 3A or 3B are dummy nodes used in the generation and solution of an expanded graph and weight matrix. The dummy nodes function essentially the same as the original nodes, but would not represent actual suppliers or bidders and also, as discussed below, are not degree constrained during the b-matching operation performed on the expanded graph and weight matrix.

Thus, each supplier node, customer node and dummy node may only require access to a vector, defining the potentially connected customer and supplier node weights and a portion of the degree distribution information. In an architecture embodiment for solving the bipartite graph problem, the expanded graph and matrix data may be apportioned among different computers or processors such that each receives only the lists of its suppliers or customers and the associated weights. Other than that, the only other information required for a complete solution, as will become clear below, is a train of messages from other nodes, where each message may be a simple scalar.

A matching can be obtained that progressively seeks an optimization of the above problem by having each customer node keep a score of, for example, how much better buying from each supplier node is than buying from other suppliers. Also, each buyer node may keep a score of how much better selling to each customer node is than selling to other customers.

Initially, the score may be just the dollar values represented by the weights. In the process described below, figuratively speaking, as the scores are updated, the supplier nodes tell the customer nodes how much potential money is lost if they are chosen according to their current scores and the customers tell the suppliers similarly. All the scores are continuously updated using this data which may be described as passing messages among the nodes, where the messages contain the information to keep score. Eventually, if the scores are updated according to subject matter described below, the scores progress toward an optimum sorted list of suppliers for each customer and a sorted list of customers for each supplier. Then each supplier or customer node's information can be used to selected that supplier or customer's best one or more matches.

In the approach described, each node updates a value corresponding to each of the supplier nodes and customer nodes, with a processor. The process may be described as belief propagation, and entails passing messages between adjacent nodes according to the following protocol:

The bipartite dense maximum weight perfect b-matching problem is of the form:

argmax_{A}Σᵢ₌₁^{m}Σⱼ₌ₘ₊₁^{m+n}AᵢⱼW(xᵢ,xⱼ) (47)

s·t·Σⱼ₌₁^{m+n}Aᵢⱼ=bᵢ,∀ᵢ, Aᵢⱼ=Aⱼᵢ,∀(i,j). (48)

The solver is given node descriptors (x₁, . . . , xₘ₊ₙ) drawn from space Ω, a weight function W:(Ω, Ω) [symbol] [symbol] , and a set of target degrees {b₁, . . . , bₘ₊ₙ}, where each bᵢε [symbol] . The goal is to output a symmetric, binary adjacency matrix Aε [symbol] ^{(m+n)×(m+n)} whose entries Aᵢⱼ=1 for all matched edges (xᵢ, xⱼ) and are otherwise zero. In the bipartite scenario, edges may only be matched between nodes {x₁, . . . , xₘ} and nodes {xₘ₊₁, . . . , xₘ₊ₙ} but not within each set. This can be implemented with abuse of notation by defining the weight function W to output −∞ for any edges within bipartitions. This same problem can be expressed in many other forms, including graph notations using node and edge sets, but when considering the dense bipartite form of the problem, it is convenient to use matrix notation.

A simplified update rule for message updates which allows for the standard O(N²) space and O(N²) per-iteration running time can be expressed as:

Bᵢⱼ^{t}=W(xᵢ,xⱼ)−σ_{b}_{ⱼ}({Bⱼₖ^{t-1}|k≠i}). (49)

where σ represents a selection operation, which is a key component of the simplified belief propagation algorithm, and Bᵢⱼ^{t} is the belief value for the edge between xᵢ and xⱼ at iteration t, the belief propagation maintaining a belief value for each edge, which, in the dense case, is conveniently represented as a matrix B. The selection operation is the operation that finds the k'th largest element of a set for some index k. For notational convenience, the selection operation over any set S is denoted as:

σₖ(S)=sεS where|{tεS|t≧s}|=k. (50)

In the equations, indices range from 1 to (m+n), unless otherwise noted, and are omitted for cleanliness. The key for reducing memory usage is that the full beliefs need not be stored (not even the compressed messages). Instead, by unrolling one level of recursion, all that need to be stored are the selected beliefs, because the selection operation in Equation (48) only weakly depends on index i. That is, the selection operation is over all indices excluding i, which means the selected value will be either the bⱼ'th or the bⱼ+1'th greatest element:

σ_{b}_{ⱼ}({Bⱼₖ^{t-1}|k≠i})ε{σ_{b}_{ⱼ}({Bⱼₖ^{t-1}|k}),σ_{b}_{ⱼ}₊₁({Bⱼₖ^{t-1}|k})}. (51)

Thus, once each row of the belief matrix B is updated, these two selected values can be computed and stored, and the rest of the row can be deleted from memory. Any further reference to B is therefore abstract, as it will not be fully stored. Any entry of the belief matrix can be computed in an online manner from the stored selected value. Let αⱼ be the negation of the bⱼ'th selection and βⱼ be that of the bⱼ+1'th selection. Then the update rules for these parameters are:

αⱼ^{t}=−σ_{b}_{ⱼ}({Bⱼₖ^{t-1}|k}), βⱼ^{t}=−σ_{b}_{ⱼ}₊₁({Bⱼₖ^{t-1}|k}), (52)

and the resulting belief lookup rule is:

$${B}_{ij}^{t} = W ( {x}_{i} , {x}_{j} ) + \{ \begin{matrix}{α}_{j}^{t} & if {A}_{ji}^{t} \neq 1 \\ {β}_{j}^{t} & otherwise .\end{matrix} \qquad ( 53 )$$

After each iteration, the current estimate of A is:

$${A}_{ij}^{t} = \{ \begin{matrix}1 & if {B}_{ij}^{t - 1} \geq {α}_{i}^{t} \\ 0 & otherwise\end{matrix} \qquad ( 54 )$$

which is computed when the α and β values are updated in Equation (52). When this estimate is a valid b-matching, i.e., when the columns of Aᵢⱼ sum to their target degrees, the algorithm has converged to the solution. The algorithm can be viewed as simply computing each row of the belief matrix and performing the selections on that row and is summarized in Algorithm 3.
Algorithm 3: Belief Propagation for b-Matching. Computes the adjacency matrix of the maximum weight b-matching.

| | |
|---|---|
| 1: | αⱼ⁰, βⱼ⁰ ← 0, ∀j |
| 2: | A⁰ ← [0] |
| 3: | t ← 1 |
| 4: | while not converged do |
| 5: | for all j ε {1, ... , m + n} do |
| 6: | Aⱼₖ^{t} ← 0, ∀k |
| 7: | αⱼ^{t} ← −σ_{b}_{ⱼ}({Bⱼₖ^{t-1}\|k}){Algorithm 2} |
| 8: | βⱼ^{t} ← −σ_{b}_{ⱼ₊₁}({Bⱼₖ^{t-1}\|k}) |
| 9: | for all {k\|Bⱼₖ^{t-1} ≧ αⱼ^{t}} do |
| 10: | Aⱼₖ^{t} ← 1 |
| 11: | end for |
| 12: | end for |
| 13: | delete A^{t-1}, α^{t-1} and β^{t-1} from memory |
| 14: | t ← t + 1 |
| 15: | end while. |

Another enhancement aims to reduce the running time of each iteration by exploiting the nature of the quantities being selected. In particular, the key observation is that each belief is a sum of two quantities: a weight and an α or β value. These quantities can be sorted in advance, outside of the inner (row-wise) loop of the algorithm, and the selection operation can be performed without searching over the entire row, significantly reducing the amount of work necessary. This is done by testing a stopping criterion that guarantees no further belief lookups are necessary. Some minor difficulties could arise, however, when sorting each component, so the algorithm does not directly apply as-is.

First, the weights cannot always be fully sorted. In general, storing full order information for each weight between all pairs of nodes requires quadratic space, which is impossible with larger data sets. Thus, the proposed algorithm instead stores a cache of the heaviest weights for each node.

In some special cases, such as when the weights are a function of Euclidean distance, data structures such as kd-trees can be used to implicitly store the sorted weights. This construction can provide one possible variant to our main algorithm.

Second, the α-β values require careful sorting, because the true belief updates mostly include αt terms but a few β^{t} terms. Specifically, the indices that index the greatest bⱼ elements of the row should use β^{t}. One way to handle this technicality is to first compute the sort-order of the at terms and, on each row, correct the ordering using a binary search-like strategy for each index in the selected indices. This method is technically a logarithmic time procedure, but requires some extra indexing logic that creates undesirable constant time penalties.

Another approach, which is much simpler to implement and does not require extra indexing logic, is to use the sort-order of the β^{t}'s and adjust the stopping criterion to account for the possibility of unseen α^{t} values. Since the weights do not change during belief propagation, at initialization, the algorithm computes index cache Iε [symbol] ^{(m+n)×c} of cache size c, which is a parameter set by the user, where entry Iᵢₖ is the index of the k'th largest weight connected to node xᵢ and, for u=Iᵢₖ,

W(xᵢ,xᵤ)=σₖ({W(xᵢ,xⱼ)|j}). (55)

At the end of each iteration, the β^{t} values are similarly sorted and stored in index vector

eε [symbol] ^{m+n}, where, for v=eₖ, entry βᵥ^{t}=σₖ(βⱼ^{t}|j}). (56)

The selection operation from (51) is then computed by checking the beliefs corresponding to the sorted weight and β indices. At each step, maintain a set S of the greatest bⱼ+1 beliefs seen so far. These provide tight lower bounds on the true α-β values. At each stage of this procedure, the current estimates for αⱼ^{t} and βⱼ^{t} are:

\tilde{α}ⱼ^{t}←σ_{b}_{ⱼ}(S), and \tilde{β}ⱼ^{t}←min(S). (57)

Incrementally the beliefs are scanned for both index lists (I)ⱼ and e, computing for incrementing index k, Bᵢₗ_{ᵢₖ} and Bᵢₑ_{ₖ}. Each of these computed beliefs is compared to the beliefs in set S and if any member of S is less than the new belief, the new belief replaces the minimum value in S. This maintains S as the set of the greatest bⱼ+1 elements seen so far.

At each stage, the greatest possible unseen belief is bound as the sum of the least weight seen so far from the sorted weight cache and the least β value so far from the β cache. Once the estimate \tilde{β}ⱼ^{t} is less than or equal to this sum, the algorithm can exit because further comparisons are unnecessary. Algorithm 4 summarizes the sufficient selection procedure.

Algorithm 4: Sufficient Selection. Given sort-order of β^{t} values and partial sort-order of weights, selects the bⱼ'th and bⱼ+1'th greatest beliefs of row j.

| | |
|---|---|
| 1: | k ← 1 |
| 2: | bound ← ∞ |
| 3: | S ← |
| 4: | \tilde{α}ⱼ^{t} ← −∞ |
| 5: | \tilde{β}ⱼ^{t} ← −∞ |
| 6: | \tilde{β}ⱼ^{t} < bound do |
| 7: | if k ≦ c then |
| 8: | u ← Iⱼₖ |
| 9: | if u ← Iⱼₖ (u is unvisited and (Bⱼᵤ^{t-1} > min(S)) then |
| 10: | S ← (S\min(S)) ∪ Bⱼᵤ^{t-1} |
| 11: | end if |
| 12: | end if |
| 13: | v ← eₖ |
| 14: | if v is unvisited and (Bⱼᵥ^{t-1} > min(S)) then |
| 15: | S ← (S\min(S)) ∪ Bⱼᵥ^{t-1} |
| 16: | end if |
| 17: | bound ← W(xⱼ, xᵤ) + βᵥ^{t-1} |
| 18: | \tilde{α}ⱼ^{t} ← σ_{b}_{ⱼ}(S) |
| 19: | \tilde{β}ⱼ^{t} ← σ_{b}_{ⱼ}₊₁(S) |
| 20: | k ← k + 1 |
| 21: | end while |
| 22: | αⱼ^{t} ← \tilde{α}ⱼ^{t} |
| 23: | βⱼ^{t} ← \tilde{β}ⱼ^{t} |

Thus, the algorithm will never stop too early. However, the running time of the selection operation depends on how early the stopping criterion is detected. In the worst case, the process examines every entry of the row, with some overhead checking for repeat comparisons. For random orderings of each dimension (and no truncated cache size), the expected number of belief comparisons necessary is O(\sqrt{N}) to find the maximum, where N=m+n=|V|. The selection is computable with O(\sqrt{bN}) expected comparisons.

However, for problems where the orderings of each dimension are negatively correlated, the running time can be worse. In the case of b-matching, the orderings of the beliefs and potentials are in fact negatively correlated, but in a weak manner. We first establish the expected performance of the sufficient selection algorithm under the assumption of randomly ordered β values. Considering the element-wise sum of two real-valued vectors \vec{w} and \vec{β} of length N with independently random sort orders, the expected number of elements that must be compared to compute the selection of the b'th greatest entry σ_{b}({wᵢ+βᵢ|i}) is \sqrt{bN}.

The sufficient selection algorithm can be equivalently viewed as checking element-wise sums in the sort orders of the \vec{w} and \vec{β} vectors, and growing a set of k indices that have been examined. The algorithm can stop once it has seen b entries that are in the first k of both sort orders.

First consider the algorithm once it has examined k indices of each vector, and derive the expected number of entries that will be in both sets of k greatest entries. Since the sort orders of each set are random, the problem can be posed as a simple sampling scenario. Without loss of generality, consider the set of indices that correspond to the greatest k entries in \vec{w}. Examining the greatest k elements of \vec{β} is equivalent to randomly sampling k indices from 1 to N without replacement. Thus, the probability of any of the k greatest entries of \vec{β} being sampled is k/N. Since there are k of these, the expected number of sampled entries that are in the greatest k entries of both vectors is k²/N.

Determining the number of entries the algorithm must examine to have an expected b entries in the top k is next. Solving the equation b=k²/N for k yields that when k=\sqrt{bN}, the algorithm will in the expected case observe b entries in the top k of both lists, exactly the sufficient selection stopping criterion.

Applying the estimated running time to analysis of the full matching algorithm, the following arguments describe the scaling behavior of the algorithm. Assuming the β messages and the weight potentials are randomly, independently ordered, and a constant b, then the total running time for each iteration of belief propagation for b-matching with sufficient selection is O(N^{1.5}), and the total running time to solve b-matching is O(N^{2.5}).

When nodes represent actual objects or entities and the weights are determined by a function between nodes, the weight values have dependencies and are therefore not completely randomly ordered. Furthermore, the β values change during belief propagation according to rules that depend on the weights, and in some cases can cause the selection time to grow to O(N). Nevertheless, in many sampling settings and real data generating processes, the weights are random enough and the messages behave well enough that sufficient selection yields significant speed improvements.

The space requirement for this algorithm has also been reduced from the O(N²) beliefs (or messages) to O(N) storage for the α and β values of each row. This improvement is most beneficial in settings where the weights are computable from an efficient function, whereas if the weights are arbitrary, they must be explicitly stored at the cost of O(N²) memory. In most machine learning applications, however, the weights are computed from functions of node descriptor pairs, such as Euclidean distance between vectors or kernel values. In these applications, the algorithm needs only to store the node descriptors, the α and β values and, during the computation, O(N) beliefs (which can be immediately deleted before computing the next row). The weight cache adds O(cN) space, where c is a user-selected constant.

The space reduction is also significant for the purposes of parallelization. The computation of belief propagation is easy to parallelize, but the communication costs between processors can be prohibitive. With the above described algorithms, each computer in a cluster stores only a copy of the node descriptors and the current α and β values. At each iteration, the cluster must share the 2N updated α and β values. This is in contrast to previous formulations where O(N²) messages or beliefs needed to be transmitted between computers at each iteration for full parallelization. Thus, when it is possible to provide each computer with a copy of the node descriptor data, an easy parallelization scheme is to split the row updates between cluster computers at each iteration.

At each iteration, each node independently updates its beliefs by running the algorithms described above given the previous iterations' α and β vectors. This process is easily parallelizable by delegating the selection operations for nodes to different processors.

Using this parallelization scheme, each computer stores the weights for the nodes it is responsible for (or the node descriptors), and a central computer collects and distributes the computed α and β vectors. At each iteration, the central computer sends the latest belief vectors to each worker, as well as the current b-matching assignment for the nodes each worker is responsible for. After each worker computes its new belief values, it sends these new belief values and the new b-matching assignments back to the central computer. The communication cost is significantly reduced by the unrolled recursion, resulting in the central computer sending an O(N) vector to each node at each iteration and receiving O(1) data back after computation.

To avoid centralizing the process, each computer can store all of the node descriptors (or only the weights associated with assigned nodes) as well as belief vectors, sending and receiving updates from all other nodes at each iteration. In this case, each node sends O(1) data to each other node at each iteration, which results in an overall bandwidth usage of O(N²) per iteration, the same as in the centralized version.

The b-matching may also be performed using max flow methods when the graph data structure is not a bipartite graph. The messages and beliefs are stored in the data storage. Once the termination condition is met, the b-matching outputs the matching results.

There are many termination conditions that can be used with the belief propagation method. As mentioned above, the b value for the original graph nodes is constant set to the size of one of the groups of the original graph structure (e.g., n) for all. The dummy nodes remain unconstrained with regard to degree during the b-matching process.

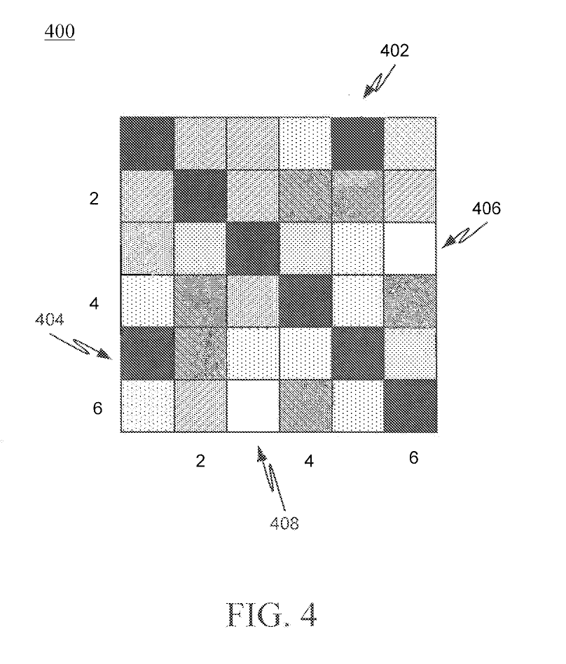

FIG. 4 is a schematic diagram of a weight matrix according to some embodiments of the disclosed subject matter. In particular, a weight matrix 400 is shown graphically with cells having shading representing various weight values. The diagonal is shaded black to indicate no weight value for a node connecting to itself. Other node cells shaded black (e.g., 402 and 404) indicate a low weight value to reduce or eliminate the potential for the result to contain an edge for those respective nodes (e.g., between nodes 1 and 5). Also, the weight matrix may be adjusted to force or encourage the result to contain an edge between two nodes by containing a high weight value at weight matrix locations corresponding to an edge between two nodes (e.g., 406 and 408).

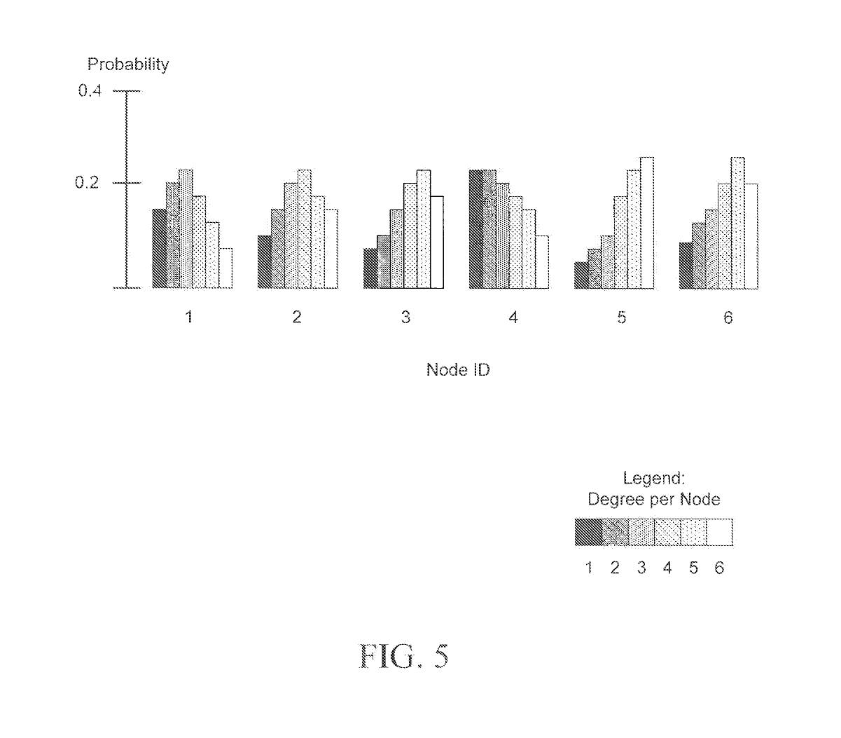

FIG. 5 is a schematic diagram of degree distribution information according to some embodiments of the disclosed subject matter. The graphical representation of node degree distributions in FIG. 5 visually illustrates the information provided by degree distribution data.

For example, Node 4 has a preference for a lower degree (say 1 or 2), while Node 5 has a preference for a higher degree (say 5 or 6). The matching system and method of this disclosure can perform matching while accommodating differing degree distribution priors or preferences by incorporating degree distribution information into an expanded weight matrix use to determine a matching result.

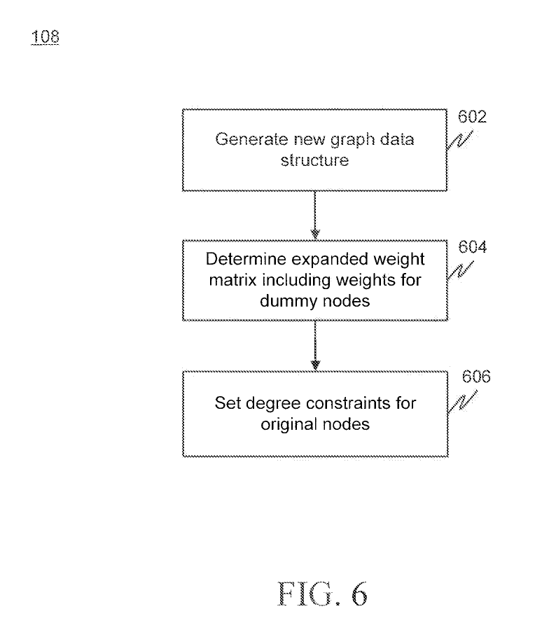

FIG. 6 is a chart of a method for generating an expanded weight matrix according to some embodiments of the disclosed subject matter. In particular FIG. 6 expands on 108 from FIG. 1A.

Processing begins at 602 where a new graph structure is generated. The new graph structure is two times the size of the original graph structure. If the original graph structure had n nodes of each type, the new graph structure is of size n×n.

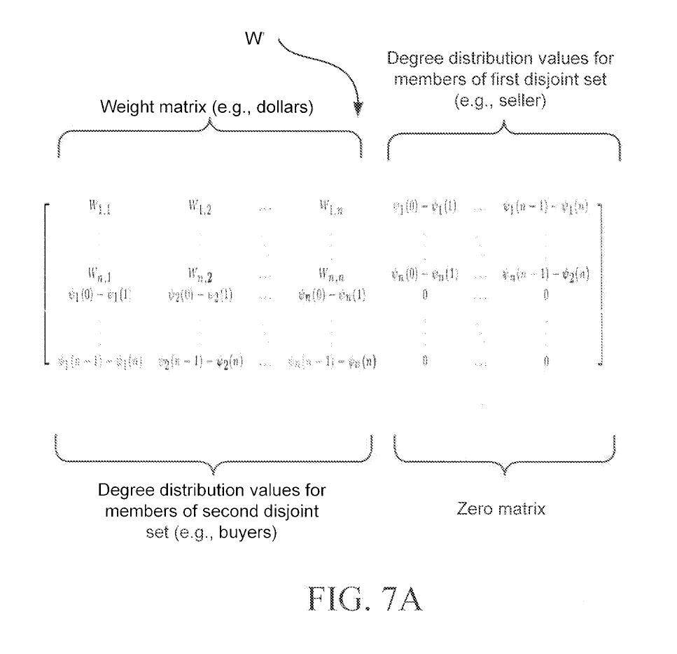

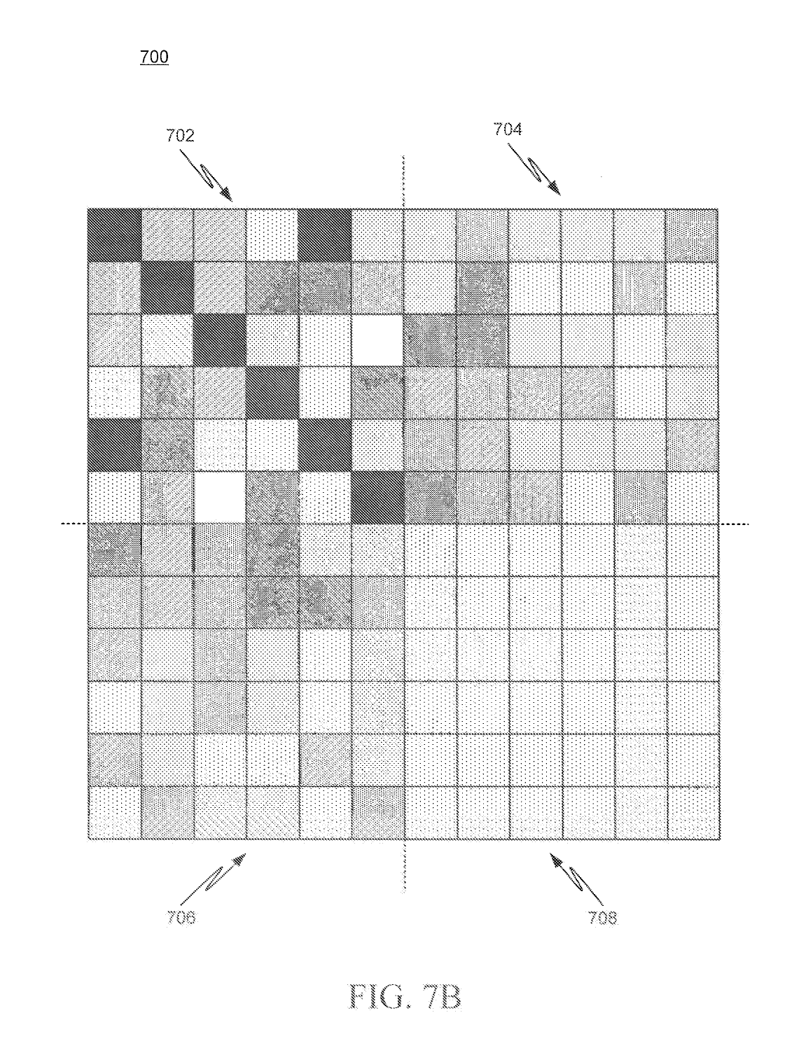

At 604, an expanded weight matrix corresponding to the expanded graph data structure is determined. The expanded weight matrix includes the original weight matrix values in one quadrant, two quadrants containing weight matrix values based on degree distribution data and a zero quadrant, as will be described in greater detail below with respect to FIG. 7A.

At 606, degree constraints are set for the original nodes within the expanded graph data structure. The degree constraint for the original nodes is set to the size of one side of the original weight matrix. In other words, if the original weight matrix is of size n×n, then the original nodes are constrained such the b=n when performing the b-matching on the expanded graph and expanded weight matrix.

FIG. 7A is a diagram showing expanded weight matrix coefficients generated according to some embodiments of the disclosed subject matter. In particular, to solve the degree distribution problem, the weight matrix W that represents the value (or relative value) of each match, is expanded doubling its size to generate an expanded weight matrix W′. The original weight matrix W (which reflects, for example, the negotiated price for a good to be sold by seller i to buyer k) forms the upper left quadrant of the expanded weight matrix W′. The upper right quadrant of the expanded weight matrix W′ includes ψᵢ(j) delta values such as, starting at the first row: ψ₁(0)-ψ₁(1), . . . , ψ₁(n−1)-ψ₁(n), and so on until the last row ψₙ(0)-ψₙ(1), . . . , ψₙ(n−1)-ψₙ(n). The lower left quadrant of the expanded weight matrix W′ includes φᵢ(j) delta values such as, starting at the first row: φ₁(0)-φ₁(1), . . . , φₙ(0)-φₙ(1), and so on until the last row φ₁(n−1)-φ₁(n), . . . , φₙ(n−1)-φₙ(n). The lower right quadrant values can all be set to zero.

The bipartite graph is expanded by adding to the seller and buyer nodes, dummy nodes to double the number of sellers and buyers. Thus, if there are n buyers and n sellers, an additional n buyers and n sellers are appended. These dummy nodes correspond to the appended delta values ψᵢ(j), φᵢ(j), or 0, respectively in the expanded weight matrix W′. In cases where the number of sellers differs from the number of buyers, the larger of the two is used as the expanded weight matrix size and the smaller side of the original weight matrix is expanded with small values (e.g., zero or negative maximum value) and dummy nodes are added to the graph data. These complete a square original and expanded weight matrix and original and expanded bipartite graph. The expanded nodes are dummy nodes similar to those used for the expanded weight matrix.

Once the expanded weight matrix W′ is created and the dummy nodes are provided, methods described below can be applied to the expanded graph and weight data. In distributed processing, the number of node processors may simply be doubled, for example, to have each processor operate and receive and send messages relating to a respective node. The value of b used for solving the problem may be set to n, namely, the number of buyers and sellers (noting that some of the buyers and sellers may be dummies and not real buyers or sellers). Once the matching problem is solved on the expanded graph using the expanded weight matrix W′, as a b-matching problem, (b=n), for example by using the disclosed belief propagation methods and systems, the b-matching solution for the original graph and weight matrix is obtained by extracting the upper left quadrant of a matrix representing the matches on the expanded graph (or by truncating the matrix to remove dummy nodes).

FIG. 7B is a graphical illustration of an expanded weight matrix 700 generated according to the coefficient matrix shown in FIG. 7A. The expanded weight matrix 700 includes the original weight matrix 400 shown in FIG. 4 as the upper left quadrant 702. The upper right 704 and lower left 706 quadrants, corresponding to edges between original nodes and dummy nodes, have been determined using coefficients as described above with respect to FIG. 7A. The lower right quadrant 708, corresponding to edges between dummy nodes only, is a zero value quadrant.

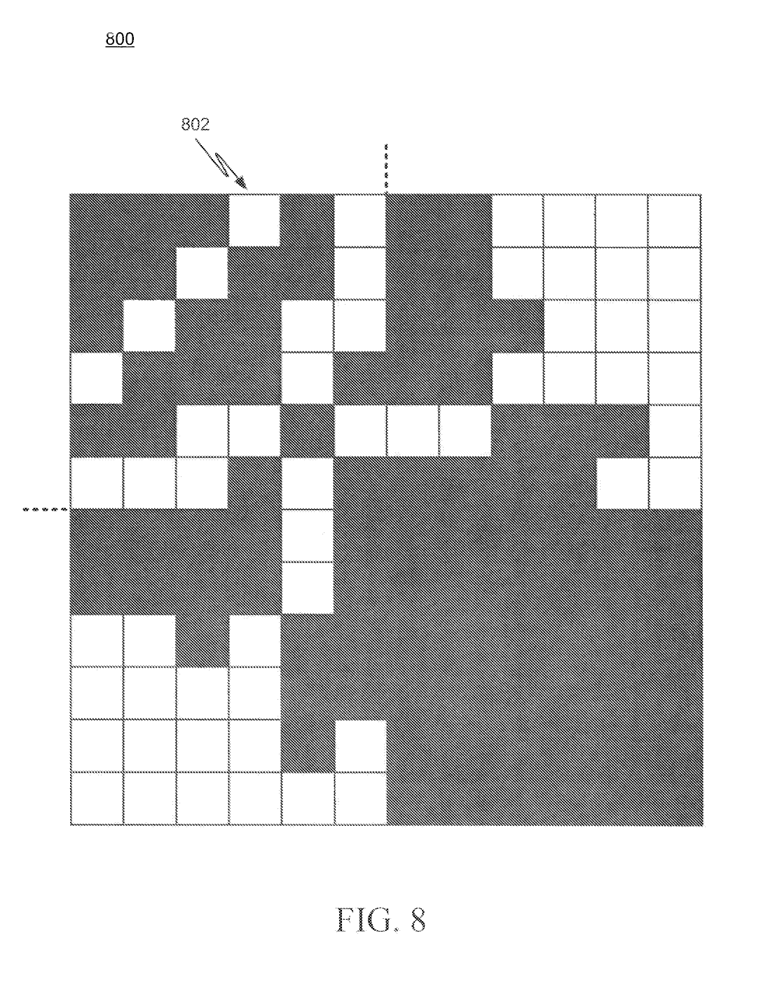

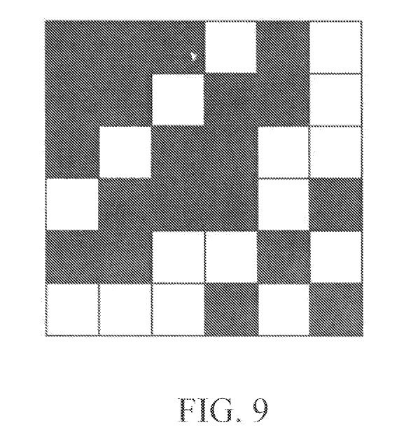

FIG. 8 is a schematic diagram showing a resulting expanded weight matrix 800 produced by performing a b-matching operation on the expanded graph structure and outputting match values as binary values. In the binary expanded result matrix, white cells indicate a match and black cells indicate no match. Within the expanded result matrix 800, the upper right quadrant 802 if of interest as a solution to the original matching problem with degree distribution and is extracted (or the dummy nodes can be truncated) to generate a final output result of the b-matching. FIG. 9 is a schematic diagram of a matching result obtained by truncating the binary expanded weight matrix shown in FIG. 8, according to some embodiments of the disclosed subject matter.

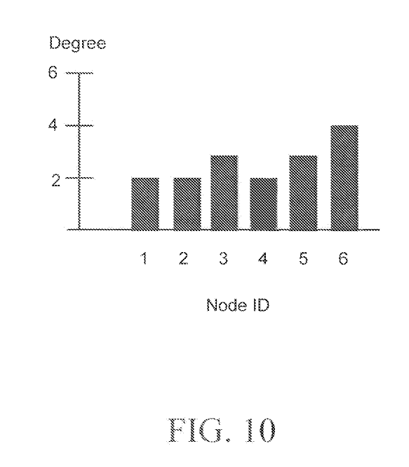

FIG. 10 is a schematic diagram of node degrees of the matching result shown in FIG. 9. For example, Nodes 1, 2 and 4 each has degree 3. Nodes 3 and 5 have degree 3 and Node 6 has degree 4. Comparing the match result degrees with the input degree distribution data shows that the matching using degree distribution provided results consistent with preferred or prior node degrees, with Nodes 3, 5 and 6 having a degree distribution favoring higher degrees and Nodes 1, 2 and 4 having degree distributions favoring lower degrees.

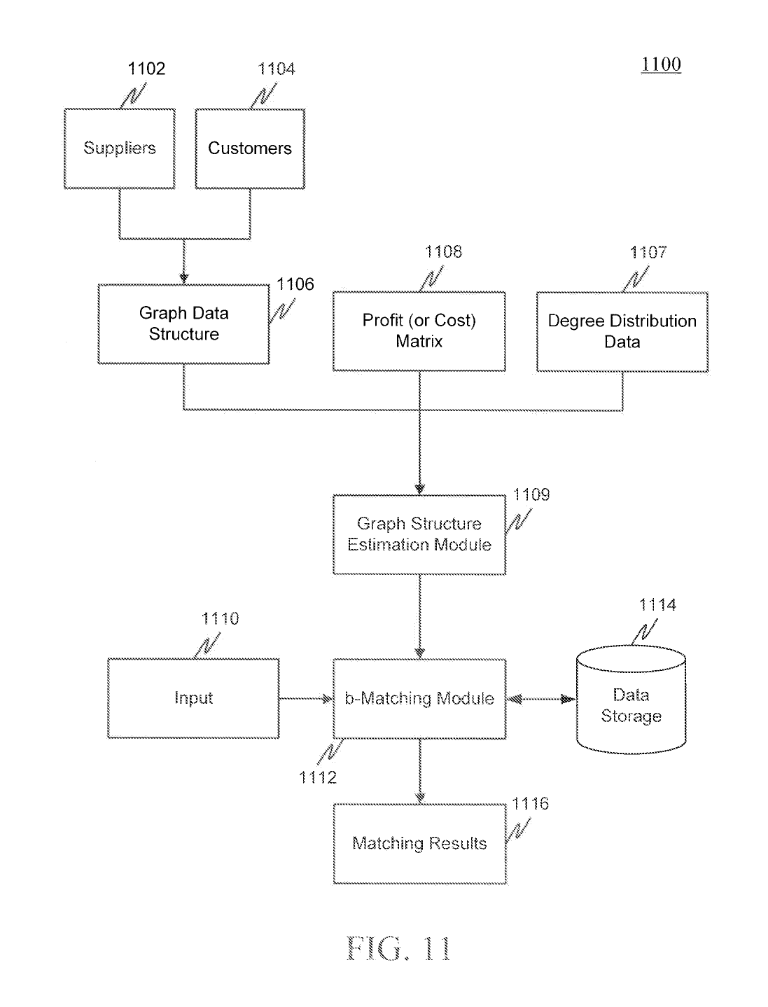

FIG. 11 is a diagram of a system for matching a first class of things to a second class of things using degree distribution information according to some embodiments of the disclosed subject matter. In particular, a belief propagation matching system 1100 includes a group of suppliers 1102 and a group of customers 1104. Each of the suppliers 1102 and customers 1104 are represented as nodes in a graph data structure 1106. The system 1100 also includes degree distribution data 1107 and a profit (or cost) matrix 1108. The graph data structure 1106 and profit matrix 1108 are provided as input to a graph structure estimation module 1109. Output from the graph structure estimation module is provided as input to a b-matching module 1112.

Also provided as input to the b-matching module 1112 is input data 1110. The b-matching module 1112 is coupled to a data storage device 1114 and provides matching results 1116 as output.

In operation, the suppliers 1102 and customers 1104 are stored as nodes or vertices of the graph data structure 1106. The degree distribution data 1107 represent distribution over degrees for each node. The profit matrix 1108 stores the edge profits (or weights) for each edge connecting a supplier and customer. The graph data structure 1106, the degree distribution data 1107 and the profit matrix 1108 can each be stored in the data storage device 1114 for retrieval by the graph structure estimation module 1109 and the b-matching module 1112.

The graph structure estimation module 1109 obtains the graph data structure 1106, the degree distribution data 1107 and the profit matrix 1108 from the data storage device 1114 and generates an expanded graph data structure and weight matrix (or profit) matrix according to the method described above with respect to FIG. 1A.

The b-matching module 1112 receives the input 1110, which can be, for example, a node of interest for b-matching. In one example, the b-matching module 1112 uses an expanded graph data structure profit matrix to perform the b-matching using belief propagation according to the following framework: (1) expressing the b-matching problem, (2) performing b-matching using maximum likelihood estimation or belief propagation, (3) simplifying messages by generating a simplified belief update rule and by unrolling recursion, and (4) updating messages using sufficient selection, as described in detail above.

The b-matching may also be performed using max flow methods when the graph data structure is not a bipartite graph. The messages and beliefs are stored in the data storage device 1114. Once the termination condition is met, the b-matching module 1112 outputs the matching results 1116. The termination condition can include any of the termination conditions described above.

The b-matching module 1112 can operate according to software instructions retrieved from a one or more computers readable medium. The software instructions, when executed by the b-matching module 1112, cause the b-matching module 1112 to perform the belief propagation matching algorithms as described above.

The b-matching module 1112 can be a general-purpose computer adapted for generalized matching using belief propagation, a special-purpose one or more computers for generalized matching using belief propagation, a programmed microprocessor or microcontroller and peripheral integrated circuit element, an ASIC or other integrated circuit, a digital signal processor, a hardwired electronic or logic circuit such as a discrete element circuit, a programmed logic device such as a PLD, PLA, FPGA, PAL, or the like.

The data storage device 1114 can be a database such as a relational database or any other suitable arrangement of data. The data can be stored in a nontransitory physical computer readable media such as a volatile or nonvolatile electronic memory, a magnetic storage device, and/or an optical storage device, or any known or later developed computer readable media.

The termination condition may be expiration of a watchdog timer, a number of messages received by each processor. Another alternative, and one that provides an optimum solution, is for each node processor to terminate when the messages stop changing. That is, the more recent message is compared to the previous message and if they are the same, the processor stops processing for sending node or when all messages are the same as corresponding prior messages processing for all nodes can be halted.

As mentioned, the termination condition can be defined as reaching a steady state with respect to message updating, that is, the changes in messages stops. Alternatively, the steady state can be defined as no further message updates being sent if the sending processor makes the determination that the updates are not changing, or when a number of update message being sent or received is below a certain threshold. Alternatively, the termination condition can be defined in terms of a number of iterations of message updating or a number of messages sent (either an aggregate number or a number per node). In another alternative, the termination condition can be defined as the elapsing of a predetermined period of time. If the termination condition has been reached, processing continues with the selection, for an input node, of a predetermined number of supplier nodes or a predetermined number of customer nodes.

Note that the graph data structure can be any type of data structure suitable for use with generalized matching using belief propagation, such as a bipartite graph data structure. The graph data structure can contain one or more nodes of the same group (unipartite case) or different groups (bipartite case). For example, the graph data structure can include supplier nodes and customer nodes, where each supplier node can be connected to one or more customer nodes, and vice versa. In respective embodiments, the graph node data structure elements correspond to physical entities such as suppliers, customers, goods and/or services. In addition, in embodiments, the nodes correspond to other entities as described below with respect to other embodiments.

The weight data such as represented by the weight matrix discussed above may represent a profit value for each edge between two nodes of the graph data structure. The weight matrix could also be a cost matrix representing a cost associated with a respective matching with suitable values for the terms to suit the computations methods. In the case of a profit matrix, the matching process typically includes a function to enhance and/or maximize profit. And in the case of a cost matrix, the matching process typically includes a function to reduce and/or minimize cost. The values in the profit matrix can be negative, zero, positive or a combination of these values.

An exemplary weight matrix may be represented by a data structure having a record corresponding to each node. The record for each node can include a list of adjacent nodes and a profit value for each of the adjacent nodes. The term “adjacent” refers to the nodes to which a given node may be connected in the same (unipartite case) or a disjoint set (bipartite case). The items of data in the profit matrix can represent physical entities or values such as actual supplier capacity, actual customer demand, monetary amounts of bidding or asking prices, monetary amounts of profit, distances, monetary costs, and/or the like. A portion of the profit matrix can be selected and provided to a respective node processor. The selected portion can represent only the profit matrix record corresponding to each respective node processor. By providing only a portion of the profit matrix to each node processor, data storage and transfer requirements can be reduced.

In operation, electronic messages are passed between adjacent nodes, which may be networked or communicate by a bus or any other data communication system. The node processor can be a computer, a single processor on a device with multiple processors, or any suitable machine capable of making the described computations and sending and receiving the described data. As described above, value (or data content) of each message is determined according to a simplified compressed message update rule. The key insight for reducing memory usage is that the full beliefs need not to be stored (not even the compressed messages). Instead, by unrolling one level of recursion, all that need to be stored are the selected beliefs. That is, the selection operation is over all indices excluding i, which means the selected value will be either the bⱼ'th or the bⱼ+1'th greatest element,

Thus, once each row of the belief matrix B is updated, these two selected values can be computed and stored, and the rest of the row can be deleted from memory. Any further reference to B is therefore abstract, as it will not be fully stored. Any entry of the belief matrix can be computed in an online manner from the stored selected value.

When this estimate is a valid b-matching, i.e., when the columns of Aᵢⱼ sum to their target degrees, the algorithm has converged to the solution. The algorithm can be viewed as simply computing each row of the belief matrix and performing the selections on that row.

Received messages may be stored by the processor in an electronic memory, such as, for example, RAM, non-volatile storage, a database or any suitable data store. The operation can be performed using the respective node processors. Downstream processing may include a process that corresponds to the particular application. For example, if the bipartite graph may describe an application in which search queries or other key words terms appearing on web pages are assigned to bidders. In that case, a first set of nodes would be the bidders and a second set of nodes would be the sellers and the downstream operation would include placing the advertisements corresponding to the bidders to corresponding locations on one or more web pages, for example, alongside search results or on other web pages.

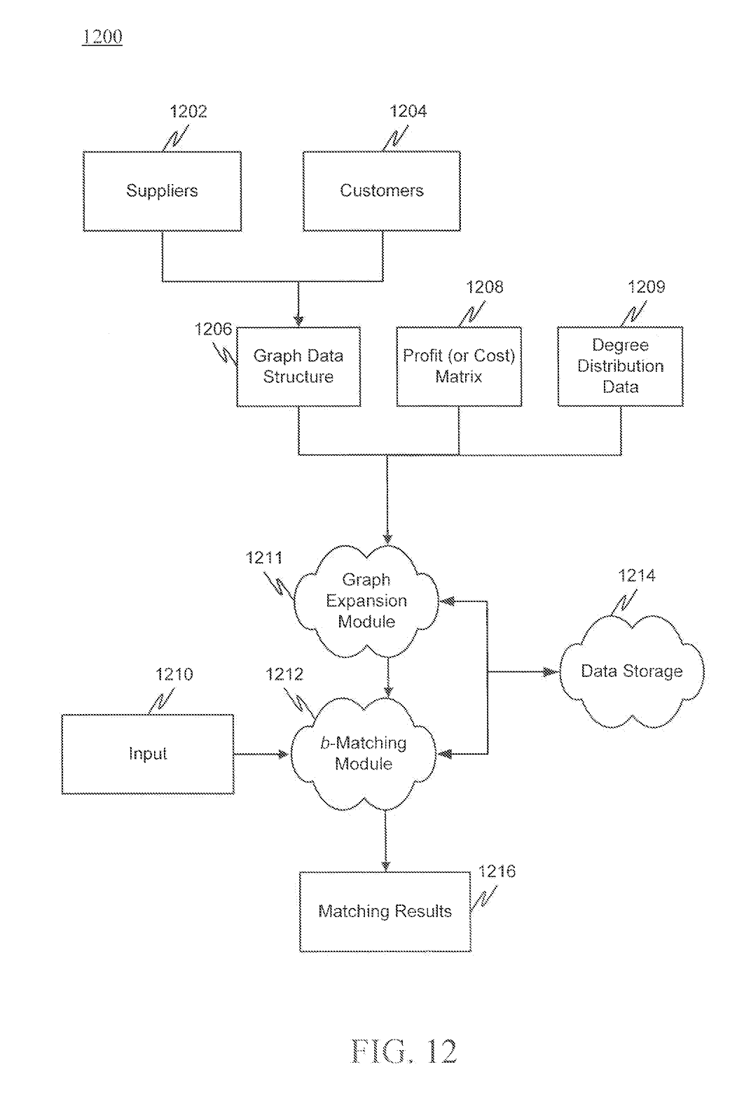

FIG. 12 is a block diagram of a system for matching using degree distribution including parallel processors according to some embodiments of the disclosed subject matter. In particular, a belief propagation matching system 1200 includes a group of suppliers 1202 and a group of customers 1204. Each of the suppliers 1202 and customers 1204 are represented as nodes arranged and stored in a graph data structure 1206. The system 1200 also includes a profit (or cost) matrix 1208 and degree distribution data 1209. The graph data structure 1206, profit matrix 1208 and degree distribution data 1209 are provided as input to a graph expansion module 1211. An expanded graph and profit matrix produce by the graph expansion module is provided as input to a b-matching module 1212. Also provided as input to the belief propagation matching system 1212 is input data 1210. The belief propagation matching system 1212 is coupled to a data storage 1214 and provides matching results 1216 as output.

In operation, the suppliers 1202 and customers 1204 are stored as nodes or vertices of the graph data structure 1206. The profit matrix 1208 stores the edge profits (or weights) for each edge connecting a supplier and customer. The degree distribution data 1209 represents preferred or prior node degree distributions. The graph data structure 1206, the profit matrix 1208 and the degree distribution data 1209 can each be stored in the data storage 1214.

The graph expansion module 1211 generates an expanded graph data structure including the original graph data structure and additional dummy nodes. The graph expansion module 1211 also generates an expanded profit matrix including the original profit matrix as one quadrant, two quadrants based on the degree distribution data 1209 and a zero quadrant, according to the method described above.

The belief propagation matching system 1212 receives the expanded graph and profit matrix produced by the graph expansion module 1211 and also receives the input data 1210, which can be, for example, a node of interest for b-matching. The belief propagation matching processor 1212 uses the expanded graph data structure and the expanded profit matrix to perform a distributed form of belief propagation for b-matching as described above. The messages and beliefs are updated using distributive (or parallel) processing and stored in the data storage 1214. Once the termination condition is met, the belief propagation matching system 1212 makes the matching results 1216 available as output. The termination condition can include any of the termination conditions described above.

The belief propagation matching system 1212 can be a distributed or parallel processing system. For example, the belief propagation matching system 1212 can be implemented as a cloud computing system. Cloud computing is a computing system in which computing resources are provided as a service over a network such as the Internet to users who do not need direct control over the technology infrastructure (“in the cloud”) that supports their computation requirements. Cloud computing also provides providing scalable virtual private servers. Examples of commercially available cloud computing offerings include Google App Engine provided by Google.com and Amazon.com's Elastic Compute Cloud (EC2). The data storage 1214 can be an Internet-based scalable storage infrastructure such as Amazon.com's Simple Storage Service (S3) or any other data storage system suitable for use with the belief propagation matching system 1212. A cloud data store may be used to store data used in any of the embodiments described herein. A cloud data store may spread stored data among a variety of different remote and local physical devices including different media and memory devices and cloud stored data may be accessed via networks or internetworks or other communication channels.

The belief propagation matching system 1212 can also be implemented according to any other suitable distributed or parallel processing architecture, including hardware and software systems containing more than one processing element or storage element, concurrent processes, multiple programs, and/or the like.

The systems and methods described above and below, herein, can be applied to matching nodes in a system represented by a unipartite graph data structure such as a social network. The systems and methods can be used to provide matching results such as social network referrals, connecting websites to other websites, routing messages on a network such as the Internet, and chip layout. In unipartite matching problems all nodes are of the same type or class (e.g., social network members) rather than disjoint sets and they can be matched with other nodes based on a value matrix having a weight or value for each edge of the unipartite graph data structure. For example, in the case of FIG. 3A, a unipartite version would have “u” nodes (302) that are the same as the “v” nodes (304).

Generalized matching or auction problems find the best assignment of goods to consumers or advertisers to consumers when given a matrix of weights or value for each possible assignment. Generalized bipartite matching is 100% solvable by linear programming, but that approach is too slow for practical applications.

The disclosed subject matter approach may employ belief propagation which gives highly improved solutions, which can be 100% optimal, but does so efficiently and can scale up to problems involving millions of users and advertisers. Other applications include network reconstruction, image matching, resource allocation, online dating, sensor networks, and others.

Online content providers can use the disclosed technology to better match advertising after a user enters a search term. Typically, online content providers show the top advertisers that bid the highest amount for a particular search term. Typically, this is done by solving a generalized matching problem. For example, assume there are 500 users and 100 advertisers. Assume each advertiser wants to show 15 ads and each user can see 3 ads. Since each advertiser bids different dollar amounts for showing their ads, the online content provider has to find the matching of ads to users that earns them the most money. When dealing with millions of users and advertisers, however, the exact solution to this problem using other techniques may be too slow and unable be distributed onto multiple machines for efficient computation. Many online content providers therefore resort to an approximate solution that was developed which gives suboptimal answers (not the most profitable) but can be solved efficiently and online. The disclosed technology permits the solution of large scale generalized matching using a distributed algorithm (belief propagation) which gives an exact answer. This may increase profit, potentially by up to 50%. It remains efficient enough to handle the scale of users/advertisers many online content providers deal with.

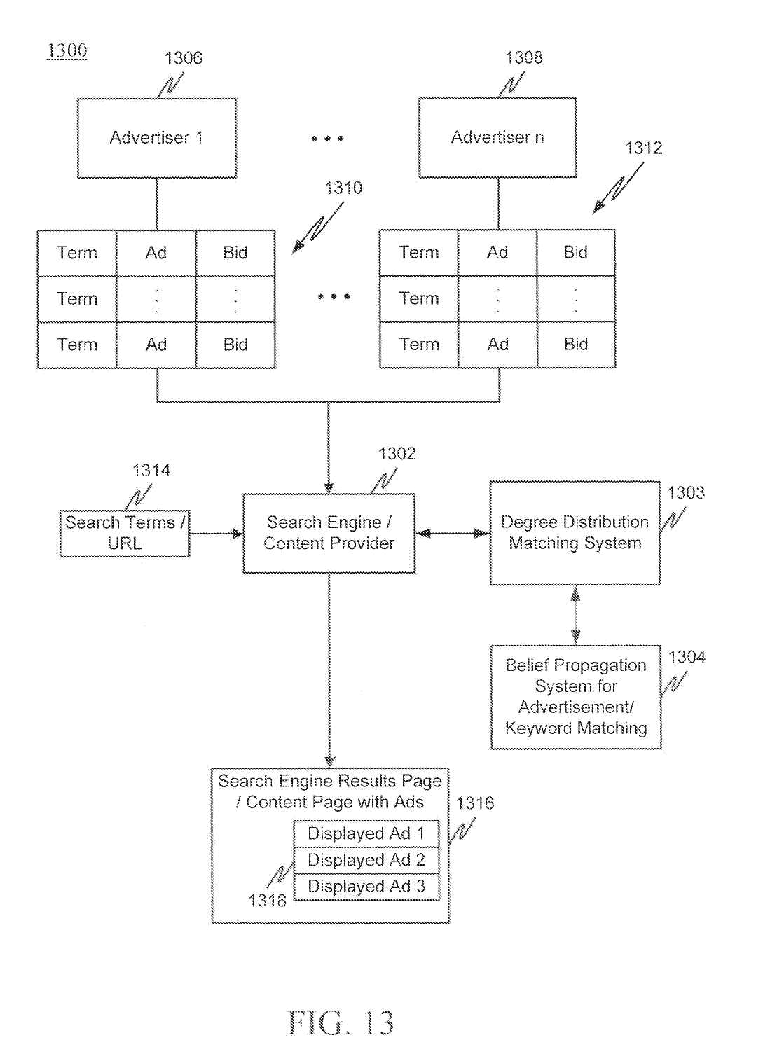

FIG. 13 is a block diagram of a system for matching advertisers with search terms using degree distribution information and belief propagation according to some embodiments of the disclosed subject matter. In particular, the system 1300 includes a search engine/content provider 1302 that is coupled to a degree distribution matching system 1303 and a belief propagation system for advertisement/keyword (search term) matching 1304. The search engine/content provider 1302 is also coupled to an electronic data storage having stored therein data representing a plurality of advertisers (1306-1308) each having a respective set of search terms (or keywords), advertisement associated with each keyword, and a bid for placing each advertisement (1310-1312). The search engine/content provider 1302 receives search terms, keywords and/or uniform resource locators (URLs) 1314 from one or more users. In response to the received input 1314, the search engine/content provider 1302 performs search term/advertiser matching using the degree distribution matching system 1303 and the belief propagation system for advertisement/keyword (or search term) matching 1304 to match a number of advertisements (three in this example) to the search term input. The b-matching advertisements (e.g., 3) are then displayed on a search engine results page (or content page of a partner website) 1316 as displayed advertisements 1318.

In this example, the nodes of the graph data structure include the advertisers/advertisements and the keywords (or search terms). The profit matrix includes the bid prices for each ad by each advertiser. The bid prices may be used as raw values or may be manipulated in order to arrive at a profit for the bid. The b value represents the maximum number of advertisements to be displayed on a results or content page (e.g., 3). However, each advertiser/advertisement node may also be subject to other constraints on its belief value such as a quota of advertisements to be displayed during a given period of time or a quota on an amount of money to be spent during a given period of time. These constraints may affect whether or not an advertiser/advertisement is selected as matching for a keyword, even if the bid for that advertiser/advertisement is high enough that it would normally be selected.

Advertisers may seek to manipulate or “game” the advertising bid system. The belief propagation methods and systems described above can be modified to provide enhanced protection against bid or ad system manipulation. For example, one bid manipulation scheme includes attempting to deplete a competitor's ad budget by placing a bid just less than the winning bid, this causes the price actually paid by the winning bidder to be artificially high and thus depletes the competitor's budget faster than would normally occur. After the competitor's budget is depleted, their bid is no longer the highest and the ad can be placed at a lower cost by the manipulator. One technique for combating this type of manipulation is to augment the b-matching algorithm with a module that can select a winner other than the first place or b-highest matches. By selecting an ad to be placed other than the normal matching ads, the manipulator's ad can be chosen, thus depleting the manipulator's budget as well. This discourages advertisers from placing artificially high bids in an attempt to deplete a competitor's budget. It will be appreciated that other now known or later developed ad auction manipulation prevention measures can be used with the disclosed subject matter.

The system for matching advertisements with search terms or keywords 1300 can comprise a second system (not shown) in addition to the belief propagation matching system for advertisement keyword matching (1304). The second system can be a bid web server, which also would typically comprise one or more computer storage mediums, one or more processing systems and one or more databases. Conventional web browsers, running on client computers can be used to access information available through the bid web server and permit advertisers to place bids for desired keywords that will be queried through the search engine or content provider. The bid web server can be accessed through a firewall, not shown, which protects account information and other information from external tampering. Additional security measures such as Secure HTTP or the Secure Sockets Layer may be provided to enhance the security of standard communications protocols.

In some of the above embodiments relating to the assignment of web advertisements according to bids, various factors can be used to modify the weight value of the weight matrix used to represent the matching problem. These can include: conversion rate; goal success rate; click through rate; how many times a user selects a given ad in a given session; a duration of time, from an ad result selection, until the user issues another search query, which may include time spent on other pages (reached via a search result click or ad click) subsequent to a given ad click; a ratio of the time, from a given ad result selection until a user issues another search query, as compared to all other times from ad result selections until the user issued another search query; time spent, given an ad result selection, on viewing other results for the search query, but not on the given ad result; how many searches (i.e., a unique issued search query) that occur in a given session prior to a given search result or ad selection; how many searches that occur in a given session after a given search result or ad selection; rather than searches, how many result page views that occur for a given search query before a given selection, this can be computed within the query (i.e., just for a unique query), or for the entire session; and rather than searches, how many search result page views that occur for a given search query after this selection, this can be computed within the query (i.e., just for the unique query), or for the entire session.

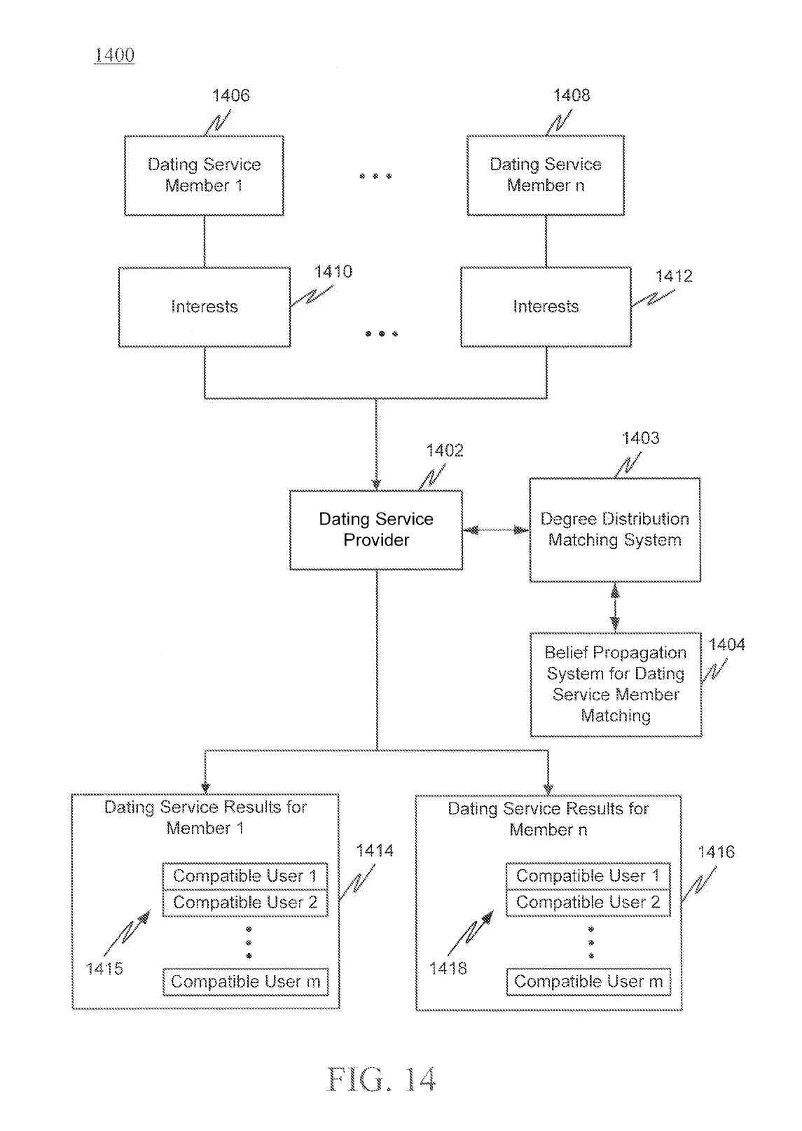

FIG. 14 is a block diagram of a system for matching dating service members using degree distribution and belief propagation according to some embodiments of the disclosed subject matter. In particular, the system 1400 includes a dating service provider 1402 that is coupled to a degree distribution matching system 1403 and a belief propagation system for dating service member matching 1404. The dating service provider 1402 is also coupled to an electronic data storage having stored therein data representing a plurality of dating service members (1406-1408) each having a respective set of interests (1410-1412). The dating service provider 1402 receives the interests (1410-1412) from one or more respective users (1406-1408). The interests (1410-1412) can be used to generate a “profit” matrix for the users, for example, by generating a value representing the interests in common for a given pair of users, which can then be expanded using degree distribution data as described above. In response to the received interests (1410-1412), the dating service provider 1402 performs member matching using the belief propagation system for dating service member matching 1404 to match each member with b other members (e.g., for a fee a dating service may provide b introductions or matches to each user). The b matching members may then be communicated to the member that they are matched with as an introduction (e.g., each user may receive an email listing the members he or she has been matched with). For example, a results set 1414 (e.g., in an email or displayed on the user's page at the dating service) can be provided for Member 1. Within the results are listed the b-matching members 1415 selected to match Member 1. And, similarly, a results set 1416 (e.g., in an email or displayed on the user's page at the dating service) can be provided for Member n. Within the results set 1416 are listed the b-matching members 1418 that have been selected to match Member n.

In this example, the nodes of the graph data structure include the members of the dating service. The “profit” matrix (or compatibility matrix) can include the predicted compatibility between a pair of members. The b value represents the number of matching or most likely compatible members to be provided to each respective member (e.g., in accordance with the service agreement with the member). However, each member node may also be subject to other constraints on its belief value such as type of other member being sought, geographic preference, other preferences, a quota of matches to be provided during a given period of time, or the like. These constraints may affect whether or not a member is selected as matching for another member, even if the “profit” or compatibility for that member is high enough that it would normally be selected.

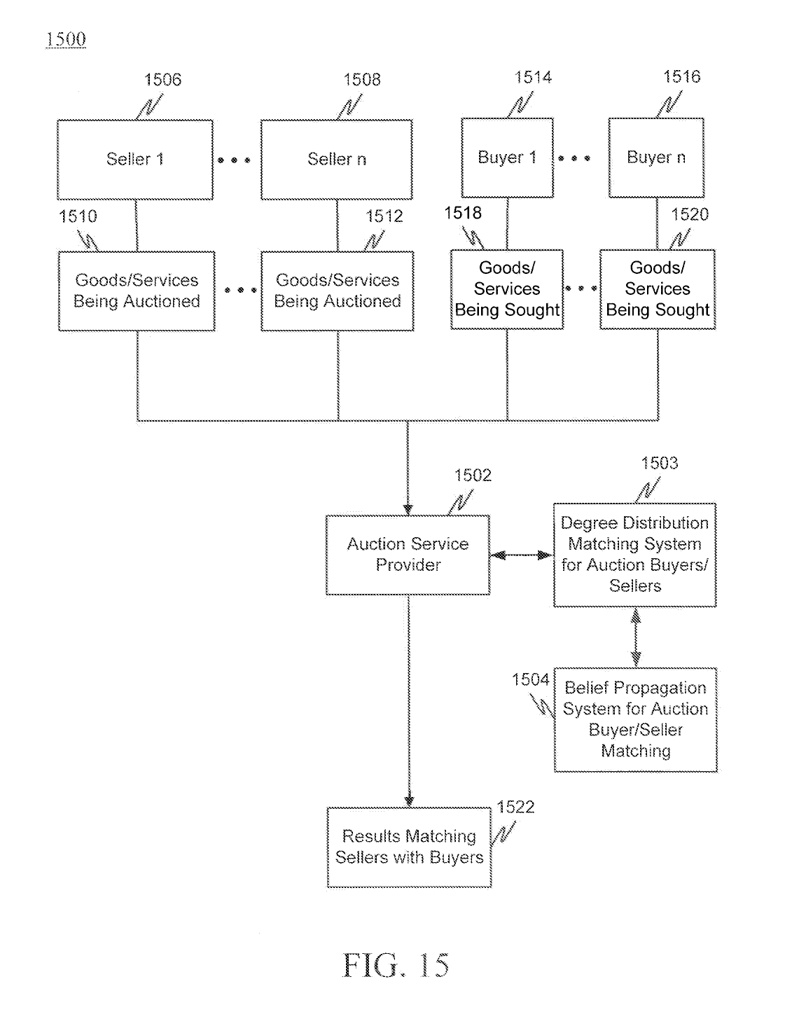

FIG. 15 is a diagram of a system for matching sellers and buyers in an auction using degree distribution and belief propagation according to some embodiments of the disclosed subject matter. In particular, the system 1500 includes an auction service provider 1502 that is coupled to a belief propagation system for auction buyer/seller member matching 1504. The auction service provider 1502 is also coupled to an electronic data storage having stored therein data representing a plurality of sellers (1506-1508) each having a respective set of goods/services being offered (1510-1512), and a plurality of buyers (1514-1516) each having a respective set of goods/services being sought (1518-1520). The auction service provider 1502 receives the goods/services being offered (1510-1512) and the goods/services being sought (1518-1520), which can be used to generate a profit matrix for matching the buyers and sellers, for example, by generating a profit value for each seller selling his goods/services to a corresponding buyer seeking those goods/services.

In response to the received goods/services being offered (1510-1512) and the goods/services being sought (1518-1520), the auction service provider 1502 performs graph and profit matrix expansion using degree distribution matching system 1503. Then, using the expanded graph data structure and expanded profit matrix, the auction service provider performs buyer/seller matching using the belief propagation system for auction buyer/seller matching 1504 to match each buyer with b sellers (e.g., such that the buyer's requirements are met). The b matching sellers may then be communicated to the buyer that they are matched with in order to complete a transaction. For example, a results set 1522 that has the b-matching between buyers and sellers can be provided as output. Alternatively, the matches for a particular buyer or seller can be communicated directly to that buyer or seller.

In this example, the nodes of the graph data structure represent goods/services being offered (1510-1512) and the goods/services being sought (1518-1520). The profit matrix can have values based on a particular buyer buying from a particular seller. For example, in the case of a buyer, the b value can represent the number of matching sellers needed to meet the buyer's requirements. In the case of a seller, the b value can represent the number of buyers needed to purchase the sellers goods/services being offered. However, each node may also be subject to other constraints on its belief value. These constraints may affect whether or not a buyer/seller is selected as matching for another buyer/seller, even if the profit for that matching is high enough that it would normally be selected.

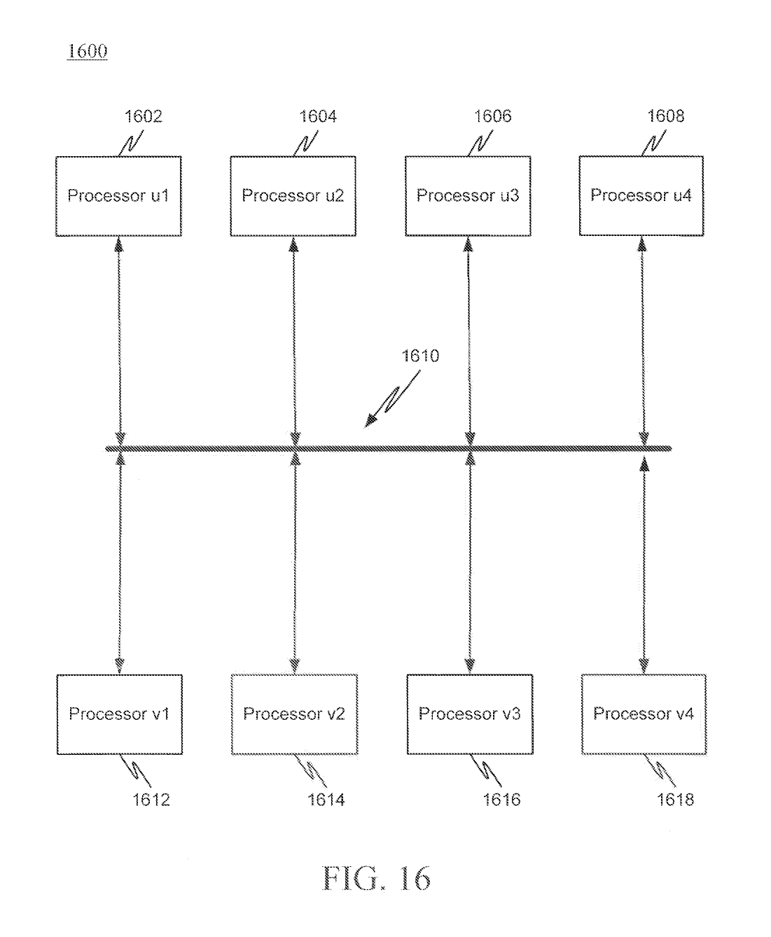

FIG. 16 is a diagram of a plurality of degree distribution matching/belief propagation processors implemented in hardware according to some embodiments of the disclosed subject matter. In particular, a system 1600 includes a plurality of belief propagation processors (1602-1608 and 1612-1618). Each of the processors is coupled to a bus 1610. The belief propagation processors are constructed for operating as nodes in a belief propagation system for matching using degree distribution as described above. The system 1600 can include processors that are stand-alone or can represent a single semiconductor device having multiple belief propagation processors constructed thereon. In operation, each hardware belief propagation processor performs the belief propagation method described above.

In addition to the applications described above, the method and system for matching using degree distribution data can also be adapted to provide solutions to other types of problems.

Embodiments of the method, system, computer program product and computer readable media for b-matching using sufficient selection belief propagation, may be implemented on one or more general-purpose computers, one or more special-purpose computers, a programmed microprocessor or microcontroller and peripheral integrated circuit element, an ASIC or other integrated circuit, a digital signal processor, a hardwired electronic or logic circuit such as a discrete element circuit, a programmed logic device such as a PLD, PLA, FPGA, PAL, or the like. In general, any device or process capable of implementing the functions or processes described herein can be used to implement embodiments of the method, system, computer program product or computer readable media for b-matching using sufficient selection belief propagation.

Furthermore, embodiments of the disclosed method, software, and computer program product (or computer readable media) for b-matching using sufficient selection belief propagation may be readily implemented, fully or partially, in software using, for example, object or object-oriented software development environments that provide portable source code that can be used on a variety of one or more computers platforms.

Alternatively, embodiments of the disclosed method for b-matching using sufficient selection belief propagation can be implemented partially or fully in hardware using, for example, standard logic circuits or a VLSI design. Other hardware or software can be used to implement embodiments depending on the speed and/or efficiency requirements of the systems, the particular function, and/or a particular software or hardware system, microprocessor, or microcomputer system being utilized. Embodiments of the method, system, computer program product and computer readable media for b-matching using sufficient selection belief propagation can be implemented in hardware and/or software using any known or later developed systems or structures, devices and/or software by those of ordinary skill in the applicable art from the functional description provided herein and with a general basic knowledge of the computer arts.

Moreover, embodiments of the disclosed method for generalized b-matching using sufficient selection belief propagation can be implemented in software stored on computer readable media (or provided as a computer program product) and adapted to be executed on a programmed general-purpose computer, a special purpose computer, a microprocessor, or the like. Also, the b-matching using sufficient selection belief propagation method of this disclosed subject matter can be implemented as a program embedded on a personal one or more computers such as a JAVA® or CGI script, as a resource residing on a server or graphics workstation, as a routine embedded in a dedicated processing system, or the like. The method and system can also be implemented by physically incorporating the method for b-matching using sufficient selection belief propagation into a software and/or hardware system, such as the hardware and software systems of a search engine, ecommerce platform, online auction, online dating, resource allocation, or image processing system.

It is, therefore, apparent that there is provided in accordance with the presently disclosed subject matter, a method, system, a computer program product and a computer readable media with software for b-matching using sufficient selection belief propagation. While this disclosed subject matter has been described in conjunction with a number of embodiments, it is evident that many alternatives, modifications and variations would be or are apparent to those of ordinary skill in the applicable arts. Accordingly, applicants intend to embrace all such alternatives, modifications, equivalents and variations that are within the spirit and scope of disclosed subject matter.

Experiments evaluating the performance of embodiments of the disclosed subject matter are presented in Appendix I.

### APPENDIX I

### Experiments

This section describes empirical results from synthetic tests, which provide useful insight into the behavior of the algorithm presented in the disclosure, and a simple test on the MNIST handwritten digits data set, which demonstrates that the performance improvements apply to real data.

### Synthetic Gaussian Data

In these experiments, the running time of the proposed algorithm is measured and compared against two baseline methods: the standard belief propagation algorithm, which is equivalent to setting the proposed algorithm's cache size to zero, and the Blossom V code, which is considered to be a state-of-the-art maximum weight non-bipartite matching solver.

For both experiments, node descriptors are sampled from zero-mean, spherical Gaussian distributions with variance 1.0, the weight function returns negative Euclidean distance, and we sample bipartitions of equal size (m=n=N/2). In the first experiment, points are sampled from [symbol] . Using different cache sizes, the running time of the algorithm is measured for varying point set sizes from 10 to 500. We set bᵢ=1, ∀i. We measure the running time using actual CPU time as well as a count of belief lookups. The square roots of per-iteration running times are drawn in FIG. 1. It is clear that for a cache size of zero, where the algorithm is default belief propagation, the running time per iteration scales quadratically and that for non-zero cache sizes, the running time scales sub-quadratically. This implies that, at least for random, iid, Gaussian data and Euclidean weights, the weights and β values are uncorrelated enough to achieve the random permutation case speedup.

For the second experiment, node descriptors are drawn from [symbol] ⁵, and we compare 1-matching performance between sufficient selection belief propagation, full belief propagation and Kolmogorov's Blossom V code. For sufficient selection, we set the cache size to c=2\sqrt{m+n}. In this case, there is no equivalent notion of per-iteration time for Blossom V, so we compare the full solution time. Full belief propagation and Blossom V seem to scale similarly, but sufficient selection improves the running time significantly. For this comparison, it is important to note some differences between the problem classes that the compared code solve: the algorithm behind Blossom V solves non-bipartite 1-matchings, whereas the proposed algorithm is specialized for bipartite b-matchings. Nevertheless, in this comparison, all algorithms are given bipartite 1-matchings. These tests were run on a personal computer with an 8-core 3 GHz Intel Xeon processor (though each run was single-threaded).

### Synthetic Adversarial Example

In this section, we present an experiment that is an adversarial example for the sufficient selection algorithm. We construct an iid sampling scheme that generates data where the cached nearest neighbors of certain points will not be the b-matched neighbors until we cache Ω(N) neighbors. The data is generated by randomly sampling points uniformly from the surfaces of two hyperspheres in high dimensional space [symbol] ⁵⁰⁰, one with radius 1.0 and the other with radius 0.1. The result is that, due to concentration, the points on the outer hypersphere are closer to all points on the inner sphere than any other points on the outer sphere, with high probability. Yet, the minimum distance b-matching will connect points according to which sphere they were sampled from. The distance between outer points to inner points will be in the range [0.9,1.1], and the distance between outer points to other outer points will concentrate around \sqrt{2} when dimensionality is much larger than N (because each vector is orthogonal with high probability). All outer points will rank the inner points as their nearest neighbors before any outer points, but due to b-matching constraints, not enough edges are available from the inner points.

This is an example where, for belief propagation to find the best b-matching, the α and β values must be negatively correlated with the weights.

Using cache sizes from 0 to m+n, where c=m+n allows the full sufficient selection, running times are compared for different sized input. From the arguments above, the sufficient selection should fail to improve upon the asymptotic time of full selection for all nodes on the outer hypersphere. Nevertheless, a constant time speedup is still achieved by exploiting order information. This may simply be because, sufficient selection speeds up performance for the points on the inner hypersphere but not for the adversarially arranged points on the outer hypersphere.

### Handwritten Digits

We perform timing tests on the MNIST digits data set, which contains 60 k training and 10 k testing handwritten digit images. The images are centered, and represented as 28×28 pixel grayscale images. We use principle components analysis (PCA) to reduce the 784 pixel dimensions of each image to the top 100 principle eigenvector projections. We use negative Euclidean distance between PCA-projected digits as edge weights, and time sufficient selection belief propagation on a subsampled data set with varying cache sizes. In particular, for this test, we sample 10% of both the training and testing sets, resulting in 6000 training and 1000 testing digits. We generate feasible b-matching constraints by setting the target degree bₜᵣε(1, . . . , 5) for the training points and the target degree bₜₑ for testing points to bₜₑ=6bₜᵣ (since there are six times as many training points).

Since there are 600 million candidate edges between training and testing examples, any algorithm that stores and updates beliefs or states for each edge, such as a conventional original belief propagation algorithm or the Blossom V algorithm cannot be run on most computers without the use of expensive virtual memory swapping. Thus, we only compare the running times of linear memory b-matching belief propagation as described in Section 2.2 using different cache sizes.

These timing tests were run on a Mac Pro with an 8-core 3 GHz Intel Xeon processor, each b-matching job running on only a single core. The results show that for a cache size of 200, the solution time is reduced from around an hour to fewer than ten minutes. Interestingly, the running time for larger b values is less, which is because belief propagation seems to converge in fewer iterations. For larger cache sizes, we achieve minimal further improvement in running time; it seems that once the cache size is large enough, the algorithm finishes selection before running out of cached weights.

Finally, using a cache size of 3500, finding the minimum distance matching for the full MNIST data set, which contains six hundred million candidate edges between training and testing examples, took approximately five hours for bₜᵣ=1 and bₜᵣ=4. The statistics from each run are summarized in Table 1. As in the synthetic examples, we count the number of belief lookups during the entire run and can compare against the total number that would have been necessary had a standard selection algorithm been used (which is (m+n)² per iteration). The running time is approximately 100 times faster than the estimated time for belief propagation with naive selection.

### DISCUSSION

This disclosure presented an enhanced belief propagation algorithm that solves maximum weight b-matching. The enhancements yield significant improvements in space requirement and running time. The space requirement is reduced from quadratic to linear, and the running time is reduced from O(N³) to O(N^{2.5}) under certain assumptions. Empirical performance is consistent with the theoretical analysis, yet the theoretical analysis needs restrictive assumptions.

Further speed and space improvements may be possible by conceding exactness in favor of an approximation scheme. For example, node descriptors can be stored using hashing schemes that preserve the reconstruction of node distances. Additionally, the initial iteration requires essentially a k-nearest neighbor computation, for which there are various approximate methods with speed tradeoffs.

1. A computerized method for generalized matching using sufficient selection belief propagation, the method comprising:
(a) providing a bipartite graph data structure having a plurality of first nodes and a plurality of second nodes, where each first node is connected to a second node by an edge;
(b) providing a weight matrix data structure having a weight value for each edge of the bipartite graph data structure, where a portion of the weight matrix is provided to each first node and each second node, the weight matrix portion including weight values for nodes adjacent to each respective first node and second node;
(c) updating a belief value corresponding to each of the first nodes and second nodes, with a processor adapted to perform belief propagation, by passing electronic messages between adjacent nodes until a termination condition is met, each message being based on the weight matrix portion values and received messages, where a value of each message is determined according to a compressed message update rule;
(d) sorting belief values and selecting a plurality of belief values to store;
(e) storing, in an electronic memory, only the selected belief values for each first node and each second node in storage locations of the electronic memory associated with the corresponding node;
(f) performing (c) through (e) iteratively until a termination condition is met;
(g) selecting, with the processor, a predetermined number of first nodes and a predetermined number of respective second nodes matching each selected first node, the selecting of the second nodes being based on updated belief values; and
(h) outputting the selected first nodes and respective matching second nodes.

2. The method of claim 1, wherein the termination condition is a predetermined number of iterations of (c) through (e).

3. The method of claim 1, wherein the termination condition is defined as a steady state of updated belief values.

4. The method of claim 1, wherein the termination condition is a number of messages sent from each node.

5. The method of claim 1, wherein the termination condition is an elapsing of a predetermined period of time.

6. The method of claim 1, wherein the termination condition is reached when columns of a solution matrix sum to a target degree.

7. The method of claim 1, wherein the first nodes are advertisements and the second nodes are search terms.

8. The method of claim 1, wherein the first nodes are sellers and the second nodes are buyers.

9. A computerized method for matching advertisements with search terms using sufficient selection belief propagation, the method comprising:
(a) providing a bipartite graph data structure having a plurality of advertiser nodes and a plurality of search term nodes, where each advertiser node is connected to a corresponding search term node by an edge;
(b) providing a profit matrix having a profit for each edge of the bipartite graph data structure;
(c) updating, with a processor adapted to perform belief propagation generalized matching, a belief value corresponding to each advertiser node connected to a selected search term node by passing messages between adjacent nodes until a termination condition is met, each message being based on profit matrix values and received messages, where each message is determined according to a compressed message update rule;
(d) sorting belief values and selecting a plurality of belief values to store;
(e) storing, in an electronic memory, only the selected belief values for each advertiser node and each search term node in storage locations of the electronic memory associated with the corresponding node;
(f) performing (c) through (e) iteratively until a termination condition is met;
(g) selecting a predetermined number of advertiser nodes matching each search term node of a group of search term nodes of interest, the matching being determined based on updated belief values of advertiser nodes adjacent to each search term node of interest; and
(h) outputting the selected advertiser nodes matching each search term node of interest.

10. The method of claim 9, further comprising displaying advertisements associated with each of the selected advertiser nodes on a search results page corresponding to the search term node associated with the selected advertiser nodes.

11. The method of claim 9, further comprising storing at each advertiser node and at each search term node a portion of the profit matrix, where each portion is selected based on adjacent nodes of each respective advertiser node and each respective search term node.

12. A processing system for matching nodes using sufficient selection belief propagation, the system comprising:
a processor adapted to load and execute software instructions stored on a computer readable medium, the software instructions, when executed, cause the processor to perform operations including:
(a) updating belief values corresponding to its respective neighbor nodes in a graph data structure, having a group of first nodes and a group of second nodes where each first node is a neighbor to at least one second node, by passing messages between neighboring nodes until a termination condition is met, each message being based on profit/cost matrix values and received messages, where a data content of each message is determined according to a message update rule;
(b) sorting belief values and selecting a plurality of belief values to store;
(c) storing, in an electronic memory, only the selected belief values for each first node and each second node in storage locations of the electronic memory associated with the corresponding node;
(d) performing (a) through (c) iteratively until a termination condition is met; and
(e) selecting a predetermined number of matching neighbor nodes, the matching being determined based on updated belief values of neighbor nodes; and
(f) outputting the selected matching neighbor nodes.

13. The system of claim 12, wherein the system includes:
a plurality of processors each corresponding to a node of the graph; and
a network coupling the plurality of processors and adapted to transfer messages between the processors.

14. The system of claim 13, wherein a cloud computing system comprises the plurality of processors.

15. The system of claim 12, wherein the first nodes are advertisers and the second nodes are search terms.

16. A method for generalized matching using sufficient selection belief propagation, the method comprising:
providing a bipartite graph data structure having a plurality of first nodes and a plurality of second nodes, where each first node is connected to a second node by an edge, and a weight matrix data structure having a weight value for each edge of the bipartite graph data structure; and
updating a belief value corresponding to each of the first nodes and second nodes, with a processor adapted to perform sufficient selection belief propagation, by passing electronic messages between adjacent nodes until a termination condition is met, sorting belief values and selecting a plurality of belief values to store, and storing, in an electronic memory, only the selected belief values for each first node and each second node in storage locations of the electronic memory associated with the corresponding node.

17. The method of claim 16, further comprising selecting, with the processor, a predetermined number of first nodes and a predetermined number of respective second nodes matching each selected first node, the selecting of the second nodes being based on updated belief values.

18. The method of claim 16, wherein a portion of the weight matrix is provided to each first node and each second node, the weight matrix portion including weight values for nodes adjacent to each respective first node and second node.

19. The method of claim 18, wherein each message is based on the weight matrix portion values and received messages, and a value of each message is determined according to a compressed message update rule.

20. The method of claim 16, further comprising outputting the selected first nodes and respective matching second nodes.

21. The method of claim 16, further comprising performing the updating, sorting and storing iteratively until a termination condition is met.

22-25. (canceled)

26. The method of claim 16, wherein the termination condition is reached when columns of a solution matrix sum to a target degree.

27. The method of claim 16, wherein the first nodes are advertisements and the second nodes are search terms.

28. The method of claim 1, wherein the first nodes are sellers and the second nodes are buyers.

29-33. (canceled)
